(19) United States
(12) Patent Application Publication
(10) Pub. No.: US 2025/0129254 A1
(43) Pub. Date: Apr. 24, 2025

(54) ACRYLATE COATING COMPOSITION FOR FORMING AN ANTIFOULING COAT

(71) Applicant: HEMPEL A/S, Kongens Lyngby (DK)

(72) Inventors: Stefan Møller OLSEN, Kongens Lyngby (DK); Albert Camós NOGUER, Kongens Lyngby (DK); Maria BILURBINA, Kongens Lyngby (DK); Nelida GIMENO, Kongens Lyngby (DK); Joan Antoni SIERRA, Kongens Lyngby (DK)

(73) Assignee: HEMPEL A/S, Kongens Lyngby (DK)

(21) Appl. No.: 18/685,026

(22) PCT Filed: Sep. 9, 2022
(86) PCT No.: PCT/EP2022/075090

§ 371 Date: Feb. 20, 2024

(30) Foreign Application Priority Data
Sep. 10, 2021 (EP) 21382812.2

(51) Int. Cl. C09D 5/16; C09D 5/14; C09D 133/12

(52) U.S. Cl. CPC C09D 5/1668; C09D 5/14; C09D 5/1675; C09D 133/12

(57) ABSTRACT

An acrylate coating composition for forming an antifouling coat is provided. The composition comprises (a) a binder comprising a (meth)acrylate polymer, wherein said (meth)acrylate polymer is formed by polymerisation of a monomer mixture comprising an alkyl (meth)acrylate monomer, or mixture of alkyl (meth)acrylate monomers, wherein said alkyl (meth)acrylate monomer, or mixture of alkyl (meth)acrylate monomers are present in said monomer mixture in an amount of at least 90% by weight of said monomer mixture; (b) one or more non-reactive polyoxyalkylene-modified silicone oils; and optionally (c) one or more solvents. A non-erodible antifouling coat, based on such a coating composition, is also provided.

### TECHNICAL FIELD

The present invention relates to the field of antifouling coats, specifically non-erodible antifouling coats. An acrylate coating composition for forming an antifouling coat is provided. The composition comprises (a) a binder comprising a (meth)acrylate polymer, wherein said (meth)acrylate polymer is formed by polymerisation of a monomer mixture comprising an alkyl (meth)acrylate monomer, or mixture of alkyl (meth)acrylate monomers, wherein said alkyl (meth)acrylate monomer, or mixture of alkyl (meth)acrylate monomers are present in said monomer mixture in an amount of at least 90% by weight of said monomer mixture; (b) one or more non-reactive polyoxyalkylene-modified silicone oils; and (c) one or more solvents. A non-erodible antifouling coat, based on such a coating composition, is also provided.

### BACKGROUND

Antifouling paints are used to prevent settlement and growth of marine organisms. These paints generally comprise a film-forming binder, together with different components such as pigments, fillers, solvents and/or biologically active substances.

One class of antifouling paints includes hydrolysable (i.e., erodible or “self-polishing”) coatings, such as those described in WO2018086670 and the references described therein. The polishing properties of the coating enable the surface erosion and/or solubilisation in a sufficient rate to follow the biocide leaching front, so that the leach layer, devoid of biocides, is kept constant at a reasonably thickness to guarantee effective biocide lixiviation and antifouling performance. Hydrolysable coatings typically require regular maintenance, and their performance can be heavily dependent on the speed and activity of a marine vessel.

Another class of paints are “fouling release coatings”, and includes silicone formulations, based on polysiloxane chemistry. These coatings rely on physical means, this being mainly a factor of modulus of elasticity and surface tension, to create a low fouling surface. In fouling release coatings, the adhesion between fouling organisms and the surface is minimized, so that the fouling can be removed by hydrodynamic stress during navigation or simple mechanical cleaning. Traditional polydimethylsiloxane (PDMS) coatings have shown difficulty in resisting slime fouling over time, thus decreasing the advantage of drag reduction. Furthermore, the chemical synthesis involved can be complex. Silicone-based coatings are e.g. described in WO2011076856.

Other related patent documents include WO03070832, GB2560158 and WO2020201213, which are hereby incorporated by reference. Lejars (in: Lejars et al. Fouling release coatings: A nontoxic alternative to biocidal antifouling coatings, Chemical Reviews, 2012, vol 112(8), 4347-4390), section 3.1.1.1 describes an insoluble matrix of e.g., acrylics where a toxicant is gradually released when seawater spread through the pores of the polymer available by released toxicant. The lifetime of such coatings is short (typically between 12-24 months), they have limited use, and biocide loading is high.

The above technologies often involve complex synthesis and high cost, high reactivity and poor in-can stability when not correctly formulated. Further, silicone formulations have the drawback that they tend to become damaged when subjected to mechanical cleaning. The present inventors are seeking a cheap and convenient coating composition which can give rise to at least the same valuable properties, but which can be easily synthesized/formulated and hence readily produced on an industrial scale. In particular, the binder is non-erodible. The present invention discloses a coating composition, which provides reliable antifouling performance based on a more cost-effective and simple chemistry. In addition, the present invention is well suited to accommodate underwater cleanings in that it provides a coating that does not erode when subjected to mechanical washing.

JP2021085028A discloses an antifouling coating for fishing nets comprising a (meth)acrylic ester polymer, an ethylene-vinyl acetate copolymer, a silicone oil, and a biocide. The coating is applied to the fishing nets by dipping.

CN110681552A relates to an abrasion-resistant, super-hydrophobic coating prepared by mixing an acrylate copolymer and BYK-333—a polyoxyalkylene modified silicone oil—then adding a blended solution of ethyl acetate and butyl acetate, and adipic acid/neopentyl glycol/trimellitic anhydride copolymer, acetyl tributyl citrate acetate, and epoxy resin are sequentially added after stirring, nitrocellulose is added to obtain a solution A. The solution is applied by spin coating.

WO2017220097A1 discloses an erodible antifouling coating comprising an erodible non-silicone based binder system, such as silyl acrylate, a metal-containing biocide and polyoxyalkylene-modified silicone oils.

KR20140117922A disclosing a copolymeric binder comprising a metal-containing hydrolysable copolymer, a polyether modified silicone oil and fumed silica. The compositions is prepared by mixing at 120-150° C. for more than 6 hours to avoid partial gelation and physical property issues.

### SUMMARY

It has been found by the present inventor(s) that it is feasible to provide a coating composition which forms a non-erodible antifouling coat, from simple, cheap, non-reactive ingredients. The coat formed by this coating composition is therefore believed to be easy-to-clean, due to the non-erodible coating.

So, in a first aspect, a coating composition according to claim 1 is provided. A non-erodible antifouling coat according to claim 17 is also provided. A substrate, being coated on at least one surface thereof with an antifouling coat according to the invention is also provided. Furthermore, a multilayer antifouling coat system, comprising at least two paint coats, at least one of said paint coats being the non-erodible antifouling coat according to the invention is provided. A method for coating a substrate, comprising applying the acrylate coating composition of the invention, is also provided.

Further details of the technology are provided in the dependent claims, as well as the following description and examples.

### DETAILED DISCLOSURE

The inventors of the present invention have developed a novel coating composition, which surprisingly works without a biocide, suitable for use in marine locations where biocide-containing compositions are restricted or completely outlawed.

The coating is particularly suitably for the “yacht” segment, and not only as a traditional conventional marine coating, as it can be applied regularly (e.g. before every season) as is based on a more cost-effective and simple chemistry. The “yacht” segment is not meant as limited to a particular size or type of vessel, but is intended to mean non-commercial vessels synonymous with “pleasure boats”.

Conventional antifouling systems contain erodible binders in which the binder slowly dissolves/breaks down in water. Now the inventors found that a non-erodible binder type is very useful and that, therefore, cheaper materials can be used etc.

The present antifouling coat further has the advantage that it may be washed without erosion of the coat (e.g. during mechanical or high-pressure washing).

### Definitions

The term “(meth)acrylate” includes both acrylate and methacrylate compounds.

Coating compositions (occasionally referred to as “paints” or “paint compositions”) typically consists of a binder phase (which forms the paint film upon drying and thereby corresponds to the continuous phase of the final paint coat) and a pigments phase (corresponding to the discontinuous phase of the final paint coat). In the present technology, the solvent-borne coating composition comprises a physically drying binder which differs from a chemically hardening binder in that the binder components (i.e. individual molecules) of the binder in the dry coat are already present in the same form in the wet coating composition. There is no change in the binder composition or the molecular structure or size of the binder components. The coat is formed entirely by evaporation of solvents, leaving the binder molecules as chains coiled up and intertwined in the coat.

In a first main aspect, therefore, an acrylate coating composition is provided for forming an antifouling coat, said composition comprising
a. a binder comprising a (meth)acrylate polymer, wherein said (meth)acrylate polymer is formed by polymerisation of a monomer mixture comprising an alkyl (meth)acrylate monomer, or mixture of alkyl (meth)acrylate monomers, wherein said alkyl (meth)acrylate monomer, or mixture of alkyl (meth)acrylate monomers are present in said monomer mixture in an amount of at least 90% by weight of said monomer mixture;
b. one or more non-reactive polyoxyalkylene-modified silicone oils; and,
c. optionally, one or more solvents.

In a second main aspect, a non-erodible antifouling coat is provided which can be obtained by coating and drying the acrylate coating composition of the first main aspect. The antifouling coat comprises:
a. a binder comprising a (meth)acrylate polymer, as defined herein;
b. one or more non-reactive polyoxyalkylene-modified silicone oils as defined herein,
c. optionally, one or more biocides, as defined herein, and
d. optionally, one or more sterically hindered amines as defined herein.

All details and embodiments of the binder, (meth)acrylate polymer, non-reactive polyoxyalkylene-modified silicone oils, biocides, and sterically hindered amines described for the coating composition of the first main aspect are equally relevant for the antifouling coat of the second main aspect.

### The Binder

The binder comprises a (meth)acrylate polymer. The (meth)acrylate polymer is preferably the sole binder component of the binder, but may be used in combination with other binder component like polymers, co-polymers and rosins, as will be described further below. The combination of the particular (meth)acrylate polymers and any further polymers, co-polymers and rosins is commonly referred to as the binder which constitutes the binder phase, i.e. the continuous phase, of the final coat.

The acrylate coating composition suitably comprises the (meth)acrylate polymer in an amount of 40-85% volume solids, preferably 50-70% volume solids.

The alkyl (meth)acrylate monomer, or mixture of alkyl (meth)acrylate monomers, are suitably present in said monomer mixture in an amount of at least 95%, such as at least 98% or at least 99% by weight of said monomer mixture; or wherein said monomer mixture consists essentially of an alkyl (meth)acrylate monomer, or mixture of alkyl (meth)acrylate monomers. In other words, the (meth)acrylate polymer is made up principally or entirely of alkyl (meth)acrylate monomers; as these monomers are generally unreactive, the reactivity of the coating composition (e.g. to binding with marine organisms) is thus limited.

Preferred (meth)acrylate polymers present in the composition of the present invention comprise 90-100 wt %, more preferably 95-100 wt % and still more preferably 98-100 wt % (meth)acrylate monomers, based on the dry weight of the polymer. Preferred (meth)acrylate polymers present in the antifouling coating composition of the present invention do not comprise any silicon (Si) or metal containing monomers.

The (meth)acrylate polymer present in the antifouling coating composition of the present invention may be a homopolymer or a copolymer. When present as a copolymer, (meth)acrylate polymer comprises at least two different (meth)acrylate monomers. The weight ratio of the different (meth)acrylate monomers in the polymer is preferably in the range 100:0 to 0:100, more preferably 95:5 to 10:90, still more preferably 90:10 to 30:70, and even more preferably 50:50.

Preferred monomers present in the (meth)acrylate polymer present in the antifouling coating composition of the present invention include methyl acrylate, ethyl acrylate, tert-butyl acrylate, n-butyl acrylate, isobutyl acrylate, hexyl acrylate, 2-ethylhexyl acrylate, octyl acrylate, isooctyl acrylate, decyl acrylate, isodecyl acryate, dodecyl acrylate, tridecyl acrylate, octadecyl acrylate, acrylic acid, 2-hydroxyethyl acrylate, 4-hydroxylbutyl acrylate, 2-methoxyethyl acrylate, tetrahydrofurfuryl acrylate, methyl methacrylate, ethyl methacrylate, tert-butyl methacrylate, n-butyl methacrylate, isobutyl methacrylate, hexyl methacrylate, 2-ethylhexyl methacrylate, octyl methacrylate, isooctyl methacrylate, decyl methacrylate, isodecyl methacdyate, dodecyl methacrylate, tridecyl methacrylate, octadecyl methacrylate, methacrylic acid, 2-hydroxyethyl methacrylate, 4-hydroxylbutyl methacrylate, 2-methoxyethyl methacrylate and tetrahydrofurfuryl methacrylate. In particular, the alkyl (meth)acrylate monomer(s) in said monomer mixture are selected from methyl (meth)acrylate, ethyl (meth)acrylate, propyl (meth)acrylate or butyl (meth)acrylate, or mixtures thereof, preferably methyl (meth)acrylate or butyl (meth)acrylate, or a mixture of methyl (meth)acrylate and butyl (meth)acrylate. The term “butyl (meth)acrylate” includes isomers i-butyl, n-butyl and t-butyl (meth)acrylate. n-Butyl acrylate, n-butyl methacrylate and methyl methacrylate are the particularly preferred monomers.

The alkyl (meth)acrylate monomer(s) in said monomer mixture is/are suitably C₁-C₁₀ alkyl (meth)acrylate monomer(s), preferably C₁-C₄ alkyl (meth)acrylate monomers.

In preferred aspects, the (meth)acrylate polymer is a homopolymer of methyl acrylate, a homopolymer of butyl acrylate, or a copolymer of methyl acrylate and butyl acrylate. Suitably, the monomer mixture comprises butyl (meth)acrylate monomer, in an amount of at least 50% by weight, such as at least 70% by weight, of said monomer mixture.

Typically, the binder constitutes 50-90%, such as 55-70%, by solids volume of the coating composition (or the antifouling coat).

When expressed by dry weight, typically the binder in total constitutes 15-75% by dry weight of the coating composition (or the antifouling coat). In preferred embodiments, the binder constitutes 16-60%, such as 18-40%, by dry weight of the coating composition (or the antifouling coat).

The binders described herein are typically of the non-erodible type. When used herein, the term “non-erodible” is intended to mean an insoluble binder matrix characterized by that the paint coat (i.e. the dried film of the coating composition) should have a polishing rate of not more than 0.5 μm per 10,000 Nautical miles (18,520 km) determined in accordance with the “lab rotor Polishing rate test” specified in the Examples section. In preferred embodiments, the polishing rate is in the range of 0-0.5 μm, in particular the polishing rate is 0 μm, per 10,000 Nautical miles (18,520 km).

The binder phase of the coating composition forms the paint film upon drying and thereby corresponds to the continuous phase of the final (dry) paint coat.

In one aspect, the coating composition comprises said (meth)acrylate polymer as the only acrylate polymer constituent of said binder. However, other polymers may be present in the binder addition to the above-specified alkyl(meth)acrylate polymers, in minor amounts. In one particular aspect, the binder further comprises (d) a silyl (meth)acrylate polymer in an amount of 0-10%, more preferably 0-5% by dry weight of the binder. In another aspect, the binder may further comprise (e) a metal (meth)acrylate polymer in an amount of 0-10%, more preferably 0-5% by dry weight of the binder. Most preferably, however, the binder does not comprise any silyl (meth)acrylate polymer (d) and/or metal (meth)acrylate polymer (e). In some embodiments, the weight average molecular weight (M_{w}) of the polymer is 20 000-300 000 g/mol, such as 30 000-200 000 g/mol, preferably 75 000-150 000 g/mol, or 30.000-100.000 g/mol, preferably 50.000-80.000 g/mol. Selection of a MW in this range can improve crack-resistant properties of the coat.

The Tg of the (meth)acrylate polymer is preferably in the range of 20-65, preferably 35-65° C., more preferably 40-65° C., and even more preferably 45-60° C., or 60-63° C.

Suitable commercially available (meth)acrylate polymers are NeoCryl B842 and NeoCryl B725 (from DSM), Degalan LP64/12, Degalan LP65/11, Degalan LP63/11, Degalan LP65/12, Degalan P24, Degalan PM602 (from Rohm), Elvacite 2044, Elvacite 2045, Elvacite 2016 (from Mitsubishi Chemical), Paraloid B-66E (from DOW) and BA123 (from LGMMA)

### Non-Reactive Polyoxyalkylene-Modified Silicone Oils

A prominent constituent of the coating compositions of the present invention is the one or more non-reactive polyoxyalkylene-modified silicone oils.

The coating composition according to the invention may comprise said non-reactive polyoxyalkylene-modified silicone oils in a total amount of 5-30% by volume solids, 5-25% by volume solids, preferably 7.5-25% by volume solids, in particular 7.5-20% by volume solids, or 10-20%, or 10-15% by volume solids, or 10-30% by volume solids of the coating composition.

The term “polyoxyalkylene-modified silicone oil” is intended to mean a non-reactive silicone oil. Polyoxyalkylene-modified silicone oils are widely used as surfactants and emulsifiers due to the content of both hydrophilic and lipophilic groups in the same molecule. The hydrophilicity is obtained by modification with polyoxyalkylene groups.

The polyoxyalkylene-modified silicone oils are non-reactive, i.e. the oils are selected so that they do not contain groups that can react with the binder or any individual binder components. Hence the polyoxyalkylene-modified silicone oils are intended to be non-reactive in particular with respect to the binder components such that the polyoxyalkylene-modified silicone oils do not become covalently linked to the binder, but instead are freely embedded into the binder film in which such silicone oils in principles may migrate more or less freely. In particular, the polyoxyalkylene-modified silicone oils are devoid of any reactive groups towards the binder components in accordance with the illustrative description of example of silicone oil (A), (B) and (C) further below. It is accepted that the silicone oils may carry “functional” groups, e.g. C—OH groups, as long as they do not in any significant way form any chemical reaction with the surrounding air or with any binder components or any additives contained in the coating composition at room temperature.

The hydrophilic character of the silicone oils is typically obtained by including pendant and/or terminal polyoxyalkylene chains as will be described in more detail in the following. The non-reactive polyoxyalkylene-modified silicone oils are silicone oils carrying polyoxyalkylene chains.

The polyoxyalkylene chains are typically selected from poly(ethylene glycol) chains, poly(propylene glycol) chains and poly(ethylene glycol-co-propylene glycol) chains), preferably poly(ethylene glycol) chains. Examples of the latter are poly(ethylene glycol)-block-poly(propylene glycol), poly(ethylene glycol)-block-poly(propylene glycol)-block-poly(ethylene glycol), poly(propylene glycol)-block-poly(ethylene glycol), poly(propylene glycol)-block-poly(ethylene glycol)-block-poly(propylene glycol), and poly(ethylene glycol-random-propylene glycol).

It has been found that particularly interesting polyoxyalkylene-modified silicone oils typically have a HLB value (as determined as described in the Examples section) in the range of 3 to 10, in particular 4 to 9.

With the aim of obtaining a suitable HLB value, it is preferred the polyoxyalkylene chains are selected from poly(ethylene glycol) chains and poly(ethylene glycol-co-propylene glycol) chains wherein the weight ratio between ethylene glycol (PEG) and propylene glycol (PPG) is more than 25:75, such as in the range of 95:5 to 25:75, e.g. 90:10 to 30:70, preferably 75:25 to 35:65, more preferably 60:40 to 40:60.

In one variant hereof, the polyoxyalkylene-modified silicone oil is a silicone having grafted thereto polyoxyalkylene chains. An illustrative example of the structure of such polyoxyalkylene-modified silicone oils is formula (A):

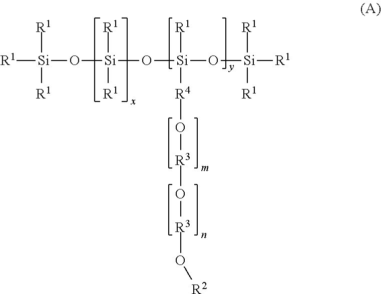

wherein
each R¹ is independently selected from C₁-s-alkyl (including linear or branched hydrocarbon groups) and aryl (e.g. phenyl (—C₆H₅)), in particular methyl;
each R² is independently selected from —H, C₁₋₄-alkyl (e.g. —CH₃, —CH₂CH₃, —CH₂CH₂CH₃, —CH(CH₃)₂, —CH₂CH₂CH₂CH₃), phenyl (—C₆H₅), and C₁₋₄-alkylcarbonyl (e.g. —C(═O)CH₃, —C(═O)CH₂CH₃ and —C(═O)CH₂CH₂CH₃), in particular —H and methyl;
each R³ is independently selected from —CH₂CH₂— and —CH₂CH(CH₃)—;
each R⁴ is selected from —(CH₂)₂₋₆—;
x is 0-2500, y is 1-100 and x+y is 1-2000;
and n is 0-50, m is 0-50 and m+n is 1-70.

In an embodiment of formula (A) herein above, n+m includes 3 to 60 repeating units, such as 3 to 50 repeating units, such as 3 to 30 or even 4 to 20 repeating units. In yet another interesting embodiment n+m includes 6 to 40 repeating units, such as 8 to 30 or 10 to 25 repeating units.

In one specific embodiment of formula (A) hereinabove, x+y is less than 25 such as less than 20, or less than 15. In another specific embodiment, x+y includes 3 to 30 repeating units, such as 3 to 20 repeating units, such as 3 to 15 or even 4 to 12 repeating units. In yet another interesting embodiment x+y includes 6 to 20 repeating units, such as 8 to 15 repeating units.

In another variant hereof, the polyoxyalkylene-modified silicone oil is a silicone having terminal polyoxyalkylene chains. An illustrative example of the structure of such polyoxyalkylene-modified silicone oils is formula (B):

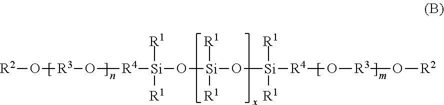

wherein
each R¹ is independently selected from C₁-s-alkyl (including linear or branched hydrocarbon groups) and aryl (e.g. phenyl (—C₆H₅)), in particular methyl;
each R² is independently selected from —H, C₁₋₄-alkyl (e.g. —CH₃, —CH₂CH₃, —CH₂CH₂CH₃, —CH(CH₃)₂, —CH₂CH₂CH₂CH₃), phenyl (—C₆H₅), and C₁₋₄-alkylcarbonyl (e.g. —C(═O)CH₃, —C(═O)CH₂CH₃ and —C(═O)CH₂CH₂CH₃), in particular —H and methyl;
each R³ is independently selected from —CH₂CH₂— and —CH₂CH(CH₃)—;
each R⁴ is selected from —(CH₂)₂₋₆—;
x is 1-2500; and
n is 0-50, m is 0-50 and m+n is 1-70.

In an embodiment of formula (B) herein above, n+m includes 3 to 60 repeating units, such as 3 to 50 repeating units, such as 3 to 30 or even 4 to 20 repeating units. In yet another interesting embodiment n+m includes 6 to 40 repeating units, such as 8 to 30 or 10-25 repeating units.

In an embodiment of formula (B) herein above, x includes 3 to 1,000 repeating units, such as 3 to 200, or 5 to 150, or 5 to 100, repeating units, e.g. 1 to 50 repeating units. In another interesting embodiment x includes 3 to 30 repeating units, such as 3 to 20 repeating units, such as 3 to 15, or even 4 to 12, repeating units. In yet another interesting embodiment x includes 6 to 20 repeating units, such as 8 to 15 repeating units.

In an embodiment of formula (B) herein above, n+m+x includes 3 to 120 repeating units, such as 3 to 100 repeating units, such as 3 to 80, or even 4 to 50, repeating units. In yet another interesting embodiment n+m+x includes 6 to 40 repeating units, e.g. 8 to 35 repeating units, such as 8 to 30 repeating units.

In still another variant hereof, the polyoxyalkylene-modified silicone oil is a silicone having terminal polyoxyalkylene chains and having grafted thereto polyoxyalkylene chains. An illustrative example of the structure of such polyoxyalkylene-modified silicone oils is formula (C):

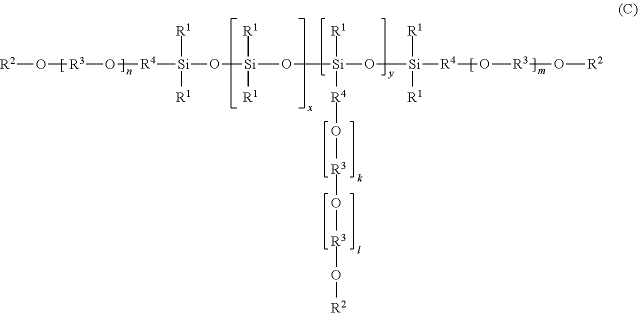

wherein:
each R¹ is independently selected from C₁-s-alkyl (including linear or branched hydrocarbon groups) and aryl (e.g. phenyl (—C₆H₅)), in particular methyl;
each R² is independently selected from —H, C₁₋₄-alkyl (e.g. —CH₃, —CH₂CH₃, —CH₂CH₂CH₃, —CH(CH₃)₂, —CH₂CH₂CH₂CH₃), phenyl (—C₆H₅), and C₁₋₄-alkylcarbonyl (e.g. —C(═O)CH₃, —C(═O)CH₂CH₃ and —C(═O)CH₂CH₂CH₃), in particular —H and methyl;
each R³ is independently selected from —CH₂CH₂— and —CH₂CH(CH₃)—;
each R⁴ is selected from —(CH₂)₂₋₆—;
x is 0-2500, y is 1-100 and x+y is 1-2000;
k is 0-50, l is 0-50 and k+l is 1-50; and
n is 0-50, m is 0-50 and m+n is 1-50.

In an embodiment of formula (C) herein above, n+m includes 3 to 60 repeating units, such as 3 to 50 repeating units, such as 3 to 30 or even 4 to 20 repeating units. In yet another interesting embodiment n+m includes 6 to 40 repeating units, such as 8 to 30 or 10-25 repeating units.

In an embodiment of formula (C) herein above, k+1 includes 3 to 60 repeating units, such as 3 to 50 repeating units, such as 3 to 30 or even 4 to 20 repeating units. In yet another interesting embodiment k+1 includes 6 to 40 repeating units, such as 8 to 30 or 10-25 repeating units.

In an embodiment of formula (C) herein above, x includes 3 to 1,000 repeating units, such as 3 to 200, or 5 to 150, or 5 to 100 repeating units, e.g. 1 to 50 repeating units. In another interesting embodiment x includes 3 to 30 repeating units, such as 3 to 20 repeating units, such as 3 to 15, or even 4 to 12, repeating units. In yet another interesting embodiment x includes 6 to 20 repeating units, such as 8 to 15 repeating units.

In an embodiment of formula (C) herein above, y includes 3 to 1,000 repeating units, such as 3 to 200, or 5 to 150, or 5 to 100 repeating units, e.g. 1 to 50 repeating units. In another interesting embodiment y includes 3 to 30 repeating units, such as 3 to 20 repeating units, such as 3 to 15, or even 4 to 12, repeating units. In yet another interesting embodiment y includes 6 to 20 repeating units, such as 8 to 15 repeating units.

In the above structures (A), (B) and (C), the group —CH₂CH(CH₃)— may be present in any of the two possible orientations. Similarly, it should be understood that the segments present x and y times typically are randomly distributed, or distributed as blocks, within the silicone structure. Also, it should be understood that groups present l and k, and m and n, times typically are distributed as blocks, but may be randomly distributed.

In these embodiments and variants, the polyoxyalkylene chains are preferably selected from poly(ethylene glycol) and poly(ethylene glycol-co-propylene glycol). Hence, in the above structures (A), (B) and (C), each R³ linking two oxygen atoms is selected from —CH₂CH₂— and —CH₂CH(CH₃)—.

It should be understood that the one or more non-reactive polyoxyalkylene-modified silicone oils, if present, may be of different types, e.g. two or more of the types described above.

Preferably, each of the above-mentioned polyoxyalkylene chains includes at least 3 repeating units, such as at least 5 repeating units. In many interesting embodiments, the polyoxyalkylene chains include 3-200 repeating units, such as 3-150, or 5-100, or 5-80 repeating units. In another interesting embodiment the polyoxyalkylene chains include 3-30 repeating units, such as 3-20 repeating units, such as 3 to 15 or even 4 to 12 repeating units. In yet another interesting embodiment the polyoxyalkylene chains include 6 to 20 repeating units, such as 8 to 15 repeating units.

In some preferred embodiments, the polyoxyalkylene chains have a number average molecular weight (Mₙ) in the range of 100-20,000 g/mol, such as in the range of 100-15,000 g/mol, in particular in the range of 200-10,000 g/mol, or in the range of 200-8,000 g/mol.

In other interesting embodiments the polyoxyalkylene chains have a number average molecular weight (Mₙ) in the range of 50-2,000 g/mol, such as 50-700 g/mol or even 100-700 g/mol.

Of particular interest are those polyoxyalkylene-modified silicone oils in which the relative weight of the polyoxyalkylene chains is 1% or more of the total weight (e.g. 1-90%), such as 5% or more (e.g. 5-80%), in particular 10% or more (e.g. 10-70%) of the total weight of the polyoxyalkylene-modified silicone oil. In one embodiment the relative weight of the polyoxyalkylene chains is in the range of 25-60% such as 30-50% of the total weight of the polyoxyalkylene-modified silicone oil.

In a preferred embodiment, the polyoxyalkylene-modified silicone oil has a number average molecular weight (Mₙ) in the range of 200-100,000 g/mol, such as in the range of 250-75,000 g/mol, in particular in the range of 500-50,000 g/mol.

In another preferred embodiment, the polyoxyalkylene-modified silicone oil has a number average molecular weight (Mₙ) in the range of 500-20,000 g/mol, such as 1,000-10,000 g/mol or 1,000-7,500 g/mol or even 1,500-5,000 g/mol.

It is also preferred if the polyoxyalkylene-modified silicone oils have a viscosity in the range of 10-20,000 mPa·s, such as in the range of 20-10,000 mPa-s, in particular in the range of 40-5,000 mPa-s.

Interesting commercially available non-reactive polyoxyalkylene-modified silicone oils are, OFX-5103, OFX-190, OFX-5103, OFX QC2-5211, OFX-5220, OFX-5329, OFX-5330, OFX-5247, OFX-Q2-5097, OFX-Q4-3669, OFX-Q4-3667, OFX-2-86, and OFX-193 (all from Xiameter), BYK-330, BYK-331, BYK-333, BYK-378, BYK-3560, BYK-3565, BYK-3566, BYK-3760 (all from BYK), SilClean 3710 from BYK, DBE-621, CMS-222 from Gelest, CoatOSil 3501, SilSurf Di 1010, Silwet 7280, CoatOSil 7210, CoatOSil 7200, CoatOSil 7602, CoatOSil 1220 (all from Momentive), TEGO Glide 410 from Evonik industries, Pluronic L64 from BASF, KF352A, KF353, KF945, KF6012, KF6017 and KF-6020 from Shin-Etsu, and MB30X-8 from Sekisui Plastics.

The one or more non-reactive polyoxyalkylene-modified silicone oils are included in the coating composition (and in the final coat) in an amount of 3-25% by dry weight, preferably 5-25%, more preferably 6.7-25%, in particular 6.7-20%, or even more preferably 6.7-15%. In certain embodiments, the one or more non-reactive polyoxyalkylene-modified silicone oils constitutes 3.0-20.0%, by dry weight, such as 5.0-15.0% by dry weight, 6.7-15.0% by dry weight, in particular 6.7-11.0% by dry weight of the coating composition/final coat.

The one or more non-reactive polyoxyalkylene-modified silicone oils are typically included in the coating composition (and in the final coat) in an amount of 0.01-40%, e.g. 0.05-30%, by solids volume. In certain embodiments, the one or more non-reactive polyoxyalkylene-modified silicone oils constitutes 5-30% by solids volume, 5-25% by solids volume, e.g. 7.5-25% by solids volume, in particular 7.5-20% by solids volume, or 10-20%, or 10-15% by solids volume, of the coating composition/final coat. In another embodiment, the one or more non-reactive polyoxyalkylene-modified silicone oils constitutes 10-30% by solids volume, of the coating composition/final coat.

### Biocides

In one aspect of the invention, the coating composition has beneficial effects, even without biocide. This aspect is useful in sensitive marine environments, and/or where local legislation prevents the use of biocides.

In an alternative aspect of the invention, the coating composition may comprise one or more biocides. In the present context, the term “biocide” is intended to mean an active substance intended to destroy, deter, render harmless, prevent the action of, or otherwise exert a controlling effect on any harmful organism by chemical or biological means.

Illustrative examples of non-metal biocides are those selected from heterocyclic nitrogen compounds such as 3a,4,7,7a-tetrahydro-2-((trichloromethyl)-thio)-1H-isoindole-1,3(2H)-dione, pyridine-triphenylborane, 1-(2,4,6-trichlorophenyl)-1H-pyrrole-2,5-dione, 2,3,5,6-tetrachloro-4-(methylsulfonyl)-pyridine, 2-methylthio-4-tert-butylamino-6-cyclopropylamine-s-triazin, and quinoline derivatives; heterocyclic sulfur compounds such as 2-(4-thiazolyl)-benzimidazole, 4,5-dichloro-2-n-octyl-4-isothiazolin-3-one, 4,5-dichloro-2-octyl-3(2H)-isothiazoline (Sea-Nine®-211N), 1,2-benzisothiazolin-3-one, 2-(thiocyanatomethylthio)-benzothiazole, (RS)-4-[1-(2,3-dimethylphenyl)ethyl]-3H-imidazole (Medetomidine, Selektope®), and 4-Brom-2-(4-chlorphenyl)-5-(trifluormethyl)-1H-pyrrol-3-carbonitril (Tralopyril, Econea®); urea derivatives such as N-(1,3-bis(hydroxymethyl)-2,5-dioxo-4-imidazolidinyl)-N,N′-bis(hydroxymethyl)urea, and N-(3,4-dichlorophenyl)-N,N-dimethylurea, N,N-dimethylchlorophenylurea; amides or imides of carboxylic acids; sulfonic acids and of sulfenic acids such as 2,4,6-trichlorophenyl maleimide, 1,1-dichloro-N-((dimethylamino)-sulfonyl)-1-fluoro-N-(4-methylphenyl)-methanesulfenamide, 2,2-dibromo-3-nitrilo-propionamide, N-(fluorodichloromethylthio)-phthalimide, N,N-dimethyl-N′-phenyl-N′-(fluorodichloromethylthio)-sulfamide, and N-methylol formamide; salts or esters of carboxylic acids such as 2-((3-iodo-2-propynyl)oxy)-ethanol phenylcarbamate and N,N-didecyl-N-methyl-poly(oxyethyl)ammonium propionate; amines such as dehydroabiethylamines and cocodimethylamine; substituted methane such as di(2-hydroxy-ethoxy)methane, 5,5′-dichloro-2,2′-dihydroxydiphenylmethane, and methylene-bisthiocyanate; substituted benzene such as 2,4,5,6-tetrachloro-1,3-benzenedicarbonitrile, 1,1-dichloro-N-((dimethylamino)-sulfonyl)-1-fluoro-N-phenylmethanesulfenamide, and 1-((diiodomethyl)sulfonyl)-4-methyl-benzene; tetraalkyl phosphonium halogenides such as tri-n-butyltetradecyl phosphonium chloride; guanidine derivatives such as n-dodecylguanidine hydrochloride; disulfides such as bis-(dimethylthiocarbamoyl)-disulfide, tetramethylthiuram disulfide; imidazole containing compound, such as medetomidine; 2-(p-chlorophenyl)-3-cyano-4-bromo-5-trifluoromethyl pyrrole and mixtures thereof.

Currently preferred examples hereof are those selected from heterocyclic nitrogen compounds such as 4,5-dichloro-2-n-octyl-4-isothiazolin-3-one, 4,5-dichloro-2-octyl-3(2H)-isothiazoline (Sea-Nine®-211N), (RS)-4-[1-(2,3-dimethylphenyl)ethyl]-3H-imidazole (Medetomidine, Selektope®) and 4-Brom-2-(4-chlorphenyl)-5-(trifluormethyl)-1H-pyrrol-3-carbonitril (Tralopyril, Econea®).

Illustrative examples of metal-containing biocides are those selected from metal-containing organic biocides like metallo-dithiocarbamates (such as bis(dimethyldithiocarbamato)zinc, zinc-ethylenebis(dithiocarbamate) (Zineb), ethylene-bis(dithiocarbamato)manganese, dimethyl dithiocarbamate zinc, and complexes between these); bis(1-hydroxy-2(1H)-pyridinethionato-O,S)-copper (copper pyrithione); copper acrylate; bis(1-hydroxy-2(1H)-pyridinethionato-O,S)-zinc (zinc pyrithione); phenyl(bispyridyl)-bismuth dichloride; and metal-containing inorganic biocides like metal biocides such as copper(I)oxide, cuprous oxide, and metallic copper, copper metal alloys such as copper-nickel alloys like copper bronze; metal salts such as cuprous thiocyanate, basic copper carbonate, copper hydroxide, barium metaborate, copper chloride, silver chloride, silver nitrate and copper sulphide; bis(N-cyclohexyl-diazenium dioxy) copper; and copper di(ethyl 4,4,4-trifluoroacetoacetate) (Cu(ETFAA)₂) as disclosed in WO2020115323A1.

Currently preferred examples hereof are copper-containing biocides and zinc-containing biocides, in particular cuprous oxide, copper pyrithione, zinc pyrithione and zinc-ethylenebis-(dithiocarbamate) (Zineb).

Presently, it is preferred that the biocide (if present) does not comprise tin.

Currently preferred biocides are those selected from the group consisting of 2,4,5,6-tetra-chloroisophtalonitrile (Chlorothalonil), copper thiocyanate (cuprous sulfocyanate), N-dichloro-fluoromethylthio-N′,N′-dimethyl-N-phenylsulfamide (Dichlofluanid), 3-(3,4-dichlorophenyl)-1,1-dimethylurea (Diuron), 4-bromo-2-(4-chlorophenyl)-5-(trifluoromethyl)-1H-pyrrole-3-carbonitrile, (2-(p-chlorophenyl)-3-cyano-4-bromo-5-trifluoromethyl pyrrole; Tralopyril), N²-tert-butyl-N⁴-cyclopropyl-6-methylthio-1,3,5-triazine-2,4-diamine (Cybutryne), (RS)-4-[1-(2,3-dimethylphenyl)ethyl]-3H-imidazole (Medetomidine), 4,5-dichloro-2-n-octyl-4-isothiazolin-3-one (DCOIT, Sea-Nine® 211N), dichlor-N-((dimethylamino)sulfonyl)fluor-N-(p-tolyl)methansulfenamid (Tolylfluanid), 2-(thiocyanomethylthio)-1,3-benzothiazole ((2-benzothiazolylthio)methyl thiocyanate; TCMTB), triphenylborane pyridine (TPBP); bis(1-hydroxy-2(1H)-pyridinethionato-O,S)-(T-4) zinc (zinc pyridinethione; Zinc Pyrithione), bis(1-hydroxy-2(1H)-pyridinethionato-O,S)-T-4) copper (copper pyridinethione; Copper Pyrithione), zinc ethylene-1,2-bis-dithiocarbamate (zinc-ethylene-N—N′-dithiocarbamate; Zineb) and diiodomethyl-p-tolylsulfone; Amical 48. Preferably, if a biocide is present in the coating, the at least one biocide is selected from the above list.

In a particularly preferred embodiment, the biocides are preferably selected among biocides which are effective against soft fouling such as slime and algae. Examples of such biocides are N²-tert-butyl-N⁴-cyclopropyl-6-methylthio-1,3,5-triazine-2,4-diamine (Cybutryne), 4,5-dichloro-2-n-octyl-4-isothiazolin-3-one (DCOIT, Sea-Nine® 211N), bis(1-hydroxy-2(1H)-pyridinethionato-O,S)-(T-4) zinc (zinc pyridinethione; zinc pyrithione), bis(1-hydroxy-2(1H)-pyridinethionato-O,S)-T-4) copper (copper pyridinethione; copper pyrithione; Copper Omadine) and zinc ethylene-1,2-bis-dithiocarbamate (zinc-ethylene-N—N′-dithiocarbamate; Zineb), copper(I) oxide, metallic copper, copper thiocyanate, (cuprous sulfocyanate), bis(1-hydroxy-2(1H)-pyridinethionato-O,S)-T-4) copper (copper pyridinethione; copper pyrithione; Copper Omadine).

In a further particularly preferred embodiment, the biocide (if present) is an organic biocide, such as a pyrithione complex, such as zinc pyrithione. Organic biocides are those either fully or in part being of organic origin.

As detailed in U.S. Pat. No. 7,377,968, in those instances in which the biocide is depleted rapidly from the film due to e.g. a high water solubility or a high level of immiscibility with the matrix composition, it can be advantageous to add one or more of the biocide(s) in encapsulated form as a means of controlling the biocide dosage and extending the effective lifetime in the film. Encapsulated biocides can also be added if the free biocide alters the properties of the binder matrix in a way that is detrimental for its use as antifouling coatings (e.g. mechanical integrity, drying times, etc.)

In a particularly preferred embodiment, the biocide is encapsulated 4,5-dichloro-2-n-octyl-4-isothiazolin-3-one (DCOIT, Sea-Nine® Ultra).

In another particularly preferred embodiment, the biocide is selected from zinc pyrithione, copper pyrithione, zinc-ethylenebis(dithiocarbamate) (Zineb), and 4,5-dichloro-2-n-octyl-4-isothiazolin-3-one (DCOIT, Sea-Nine® 211N). Of these, 4,5-dichloro-2-n-octyl-4-isothiazolin-3-one (DCOIT, Sea-Nine® 211N) is preferred, and even more preferred is 4,5-dichloro-2-n-octyl-4-isothiazolin-3-one (DCOIT, Sea-Nine® 211N) in non-encapsulated form.

In one particular aspect, the one or more biocide is a metal-containing biocide selected from bis(1-hydroxy-2(1H)-pyridinethionato-O,S)-copper (copper pyrithione); copper acrylate; bis(1-hydroxy-2(1H)-pyridinethionato-O,S)-zinc (zinc pyrithione); zinc-ethylenebis(dithiocarbamate); copper(I)oxide; cuprous oxide; metallic copper; copper metal alloys; metal salts; and bis(N-cyclohexyl-diazenium dioxy)copper.

In another particular aspect, the one or more biocide is an organic biocide selected from dichlorooctylisothiazolinone (DCOI), (RS)-4-[1-(2,3-dimethylphenyl)ethyl]-3H-imidazole, or 4-brom-2-(4-chlorphenyl)-5-(trifluormethyl)-1H-pyrrol-3-carbonitril, preferably dichlorooctylisothiazolinone (DCOI).

The biocide preferably has a solubility in the range of 0-20 mg/L, such as 0.00001-20 mg/L, in water at 25° C.

If present, the one or more biocides typically constitutes 5-15% by dry weight, e.g. 8-13% by dry weight, in particular 7-12% by dry weight, of the coating composition.

If present, the one or more biocides typically constitutes 0-15% by volume solids, preferably 5-15% volume solids, even more preferably 5-10% volume solids of the coating composition.

Suitably, if a biocide is present, the acrylate coating composition according to the invention comprises one or more biocides in a total amount of less than 0.5%, such as less than 0.1% by dry weight of the coating composition, and is preferably substantially free of biocides.

### Sterically Hindered Amines

One component of the coating composition (and corresponding coat) is one or more sterically hindered amine (in particular 2,2,6,6-tetraalkyl piperidine derivatives). The present inventors have found that the hindered amine moieties (e.g. 2,2,6,6-tetraalkyl piperidine moieties) of such sterically hindered amines when used in combination with constituents comprising poly(oxyalkylene) chains improves the antifouling performance of the immersed alkyl (meth)acrylate binder.

It appears that the existence of the sterically hindered amine motif (e.g. a 2,2,6,6-tetraalkyl piperidine motif) plays an important role for the functionality of the sterically hindered amines. Otherwise, it is envisaged that a broad range of derivatives are applicable, including those present as discrete molecule and those being part of oligomeric or polymeric structures.

In one embodiment, therefore, the acrylate coating composition according to the invention, further comprises one or more sterically hindered amines. The one or more sterically hindered amines are suitably present in a total amount of 0.06-11.9% by volume solids, such as 0.1-9.8%, or such as 0.13-8.5%, such as 0.16-6.1%, in particular 0.18-3.7% volume solids of the coating composition.

The sterically hindered amine(s) may have general formula I:

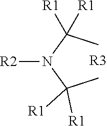

wherein
each R1 is independently linear or branched C₁-C₄ alkyl, preferably methyl;
R2 is selected from —H, optionally substituted linear or branched C₁₋₃₀-alkyl, optionally substituted linear or branched C₂₋₃₀-alkenyl, optionally substituted aryl, —OH (corresponding to N—O.), optionally substituted linear or branched C₁₋₃₀-alkoxy, optionally substituted linear or branched C₁₋₃₀-alkenyloxy, optionally substituted aryloxy, optionally substituted linear or branched C₁₋₃₀-alkylcarbonyl, optionally substituted linear or branched C₁₋₃₀-alkenylcarbonyl, and optionally substituted arylcarbonyl;
R3 is an optionally substituted divalent group forming an N-heterocyclic 5-, 6- or 7-membered ring together with the intervening —C(R1)₂—N(R2)-C(R1)₂— group.

More particularly, the sterically hindered amine(s) may be selected from 2,2,6,6-tetraalkyl piperidine derivatives, i.e. the hindered amine moieties are 2,2,6,6-tetraalkyl piperidine moieties of general formula II:

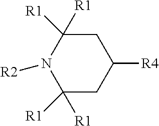

wherein R1 and R2 are defined as above—

In formula II, R4 may represent hydrogen atom(s) and/or the attachment point(s) for a polymer, or R4 represents two substituents forming a spiro structure, e.g. a spiro structure of a heterocyclyl nature. The term “spiro” has its regular meaning in organic chemistry; i.e. two or more rings which share a common atom.

In some embodiments, R4 represents H (where the 4-position of the piperidine is unsubstituted), or one or two substituents selected from C₁₋₃₀-alkyl, C₁₋₃₀-alkenyl, aryl, hydroxy, C₁₋₃₀-alkoxy, C₁₋₃₀-alkenyloxy, aryloxy, C₁₋₃₀-alkylcarbonyl, C₁₋₃₀-alkenylcarbonyl, arylcarbonyl, C₁₋₃₀-alkylcarbonyloxy, C₁₋₃₀-alkenylcarbonyloxy, and arylcarbonyloxy; and wherein the substituent R4 with the before-mentioned meanings may be linked to one or more hindered amine moieties each independently having the General Formula II.

In some embodiments, R4 is selected from C₁₋₃₀-alkyl, C₁₋₃₀-alkenyl, aryl, C₁₋₃₀-alkoxy, C₁₋₃₀-alkenyloxy, aryloxy, C₁₋₃₀-alkylcarbonyl, C₁₋₃₀-alkenylcarbonyl, arylcarbonyl, C₁₋₃₀-alkylcarbonyloxy, C₁₋₃₀-alkenylcarbonyloxy, and arylcarbonyloxy, in particular from C₁₋₈-alkoxy, C₁-s-alkenyloxy, aryloxy, C₁-s-alkylcarbonyloxy, C₁-s-alkenylcarbonyloxy, and arylcarbonyloxy.

Typically, the sterically hindered amine(s), e.g. piperidine derivative(s), are present in a total amount of 0.05-10%, such as 0.08-8%, or such as 0.1-7%, such as 0.12-5%, in particular 0.15-3%, by dry weight of said coat (or coating composition).

Without being bound to any particular theory, it is envisaged that the pKa values of the 2,2,6,6-tetraalkyl piperidine derivatives preferably should be below 8.5. Hence, it is preferred that the N is substituted (i.e. not N—H). More preferably, the pKa is below 8.0, such as below 7.0, e.g. below 6.0 or even below 5.0.

When any R group (in particular R1, R2, R3 and R4) are described as being “optionally substituted”, this means that that may be substituted at any suitable position with halogen (—F, —Cl, —Br or —I), —C₁-C₄ alkyl, or —OH.

Examples of sterically hindered amines are Tinuvin 123 (CAS no. 129757-67-1) and Tinuvin 249 (CAS no. 1445870-18-7), both from BASF, Sabostab UV 65 (CAS no. 1065336-91-5) from Sabo, ADK STAB LA-68 (CAS no. 85631-01-2), ADK STAB LA-52SC (CAS no. 91788-83-9), ADK STAB LA-57 (CAS no. 64022-61-3) from Adeka.

Further details of the sterically hindered amines can be found in EP3802709, which is hereby incorporated by reference.

### Solvents, Additives, Pigments and Fillers

The coating compositions may further comprise solvents and additives.

Examples of solvents are solvents of non-aqueous origin, such as aliphatic, cycloaliphatic and aromatic hydrocarbons such as white spirit, cyclohexane, methyl isobutyl ketone (MIBK), toluene, xylene and naphtha solvent, esters such as methoxypropyl acetate, n-butyl acetate and 2-ethoxyethyl acetate; octamethyltrisiloxane, and mixtures thereof.

In one embodiment, the solvents are selected from aliphatic, cycloaliphatic and aromatic hydrocarbons such as white spirit, cyclohexane, toluene, xylene and naphtha solvent, esters such as methoxypropyl acetate, n-butyl acetate and 2-ethoxyethyl acetate; octamethyltrisiloxane, and mixtures thereof, preferably those solvents having a boiling point of 110° C. or more.

The solvent(s) typically constitute(s) 2-50% by volume of the coating composition, such as 3-40%, or 4-30%, or 5-25% by volume of the coating composition. In an alternative, the solvent(s) typically constitute(s) 30-60% by volume of the coating composition, such as 35-50%, by volume of the coating composition.

Examples of additives are:
(i) non-reactive fluids such as organopolysiloxanes; for example polydimethylsiloxane, methylphenyl polysiloxane; petroleum oils and combinations thereof;
(ii) surfactants such as derivatives of propylene oxide or ethylene oxide such as alkylphenol-ethylene oxide condensates (alkylphenol ethoxylates); ethoxylated monoethanolamides of unsaturated fatty acids such as ethoxylated monoethanolamides of linoleic acid; sodium dodecyl sulfate; and soya lecithin;
(iii) wetting agents and dispersants such as those described in M. Ash and I. Ash, “Handbook of Paint and Coating Raw Materials, Vol. 1”, 1996, Gower Publ. Ltd., Great Britain, pp 821-823 and 849-851;
(iv) thickeners and anti-settling agents (e.g. thixotropic agents) such as colloidal silica, hydrated aluminium silicate (bentonite), aluminium tristearate, aluminium monostearate, xanthan gum, chrysotile, pyrogenic silica, hydrogenated castor oil, organo-modified clays, polyamide waxes and polyethylene waxes;
(v) dyes such as 1,4-bis(butylamino)anthraquinone and other anthraquinone derivatives; toluidine dyes, etc.; and
(vi) antioxidants such as bis(tert-butyl) hydroquinone, 2,6-bis(tert-butyl) phenol, resorcinol, 4-tert-butyl catechol, tris(2,4-di-tert-butylphenyl)phosphite, pentaerythritol tetrakis(3-(3,5-di-tert-butyl-4-hydroxyphenyl)propionate), bis(2,2,6,6,-tetramethyl-4-piperidyl)sebacate, etc.

Any additives typically constitute 0-30%, such as 0-15%, by dry weight of the coating composition. One important additive is a non-reactive silicone oil (i.e. a pure PDMS) in an amount of 3-10 wt %.

Preferably, the coating composition comprises one or more thickeners and/or anti-settling agents (e.g. thixotropic agents), preferably in an amount of 0.2-10%, such as 0.5-5%, e.g. 0.6-4%, by dry weight of the coating composition.

Furthermore, the coating composition used for forming the coat may comprise pigments and fillers.

Pigments and fillers are in the present context viewed in conjunction as constituents that may be added to the coating composition with only limited implications on the adhesion properties. “Pigments” are normally characterised in that they render the final paint coating non-transparent and non-translucent, whereas “fillers” normally are characterised in that they do not render the paint non-translucent and therefore do not contribute significantly to hide any material below the coating.

Examples of pigments are grades of titanium dioxide, red iron oxide, zinc oxide, carbon black, graphite, yellow iron oxide, red molybdate, yellow molybdate, zinc sulfide, antimony oxide, sodium aluminium sulfosilicates, quinacridones, phthalocyanine blue, phthalocyanine green, black iron oxide, indanthrone blue, cobalt aluminium oxide, carbazole dioxazine, chromium oxide, isoindoline orange, bis-acetoacet-o-tolidiole, benzimidazolone, quinaph-talone yellow, isoindoline yellow, tetrachloroisoindolinone, quinophthalone yellow.

Examples of fillers are calcium carbonate such as calcite, dolomite, talc, mica, feldspar, barium sulfate, kaolin, nephelin, silica, perlite, magnesium oxide, and quartz flour, etc. Fillers (and pigments) may also be added in the form of nanotubes or fibres, thus, apart from the before-mentioned examples of fillers, the coating composition may also comprise fibres, e.g. those generally and specifically described in WO 00/77102, which is hereby incorporated by reference.

Any pigments and/or fillers typically constitute 0-60%, such as 0-50%, preferably 5-45%, such as 5-40%, or 5-35%, or 0.5-25%, or 1-20%, by dry weight of the coating composition. Taking into account the density of any pigments and/or fillers, such constituents typically constitute 0.2-20%, such as 0.5-15% by solids volume of the coating composition With the aim of facilitating easy application of the coating composition (e.g. by spray, brush or roller application techniques), the coating composition typically has a viscosity in the range of 25-25,000 mPa·s, such as in the range of 150-15,000 mPa-s, in particular in the range of 200-4,000 mPa-s.

### EMBODIMENTS OF THE INVENTION

In view of the above, the present invention provides a broad range of antifouling coating compositions (and corresponding antifouling coats), of which the following constitute currently preferred embodiments. It should be understood that the various aspects, embodiments, implementations and features of the invention mentioned herein may be claimed separately, or in any combination:

In one aspect, the invention relates to an antifouling coating composition comprising
a) 15-75% by dry weight of an alkyl (meth)acrylate polymer
b) a non-reactive polyoxyalkylene-modified silicone oil
c) optionally, one or more solvents.

In one aspect, the invention relates to an antifouling coating composition comprising
a) 45-85% solids volume of an alkyl (meth)acrylate polymer
b) a non-reactive polyoxyalkylene-modified silicone oil
c) optionally, one or more solvents.

In one aspect, the invention relates to an antifouling coating composition comprising
a) 15-75% by dry weight of an alkyl (meth)acrylate polymer
b) 3-25% by dry weight of a non-reactive polyoxyalkylene-modified silicone oil
c) optionally, one or more solvents.

In one aspect, the invention relates to an antifouling coating composition comprising
a) 45-85% solids volume of an alkyl (meth)acrylate polymer
b) 5-30% by volume solids of a non-reactive polyoxyalkylene-modified silicone oil
c) optionally, one or more solvents.

In one embodiment, the alkyl (meth)acrylate polymer is present in an amount of 16-60% by dry weight of the coating composition/the final coat.

In one embodiment, the alkyl (meth)acrylate polymer is present in an amount of 50-70% solids volume of the coating composition.

In one embodiment, the alkyl (meth)acrylate polymer is a copolymer of methyl methacrylate and butyl methacrylate.

In one embodiment, the alkyl (meth)acrylate polymer is a copolymer of methyl methacrylate and butyl methacrylate in a ratio of 95:5 to 10:90, more preferably 90:10 to 30:70, and even more preferably 50:50.

In one embodiment, the alkyl (meth)acrylate polymer has a Tg of 20-65° C.

In one embodiment, the alkyl (meth)acrylate polymer of the compositions has a MW of 30 000-300 000 g/mol.

In a particular embodiment, the above-mentioned alkyl (meth)acrylate polymer is a homopolymer of butyl methacrylate.

In one embodiment, said antifouling coating composition is substantially free of biocides.

In one embodiment the non-reactive polyoxyalkylene-modified silicone oil is present in an amount of 3-25% by dry weight, preferably 5-25%, more preferably 6.7-25%, in particular 6.7-20%, or even more preferably 6.7-15%, of the coating composition/final coat and further the polyoxyalkylene units are selected from poly(ethylene glycol) chains and poly(ethylene glycol-co-propylene glycol) chains.

In one embodiment the non-reactive polyoxyalkylene-modified silicone oil is present in an amount of 5-30% by solids volume, preferably 5-25% by solids volume, more preferably 7.5-25% by solids volume, in particular 7.5-20% by solids volume, or even more preferably 10-20%, or in particular 10-15% by solids volume, or even 10-30% by solids volume, of the coating composition/final coat and further the polyoxyalkylene units are selected from poly(ethylene glycol) chains and poly(ethylene glycol-co-propylene glycol) chains.

In one embodiment, said antifouling coating composition further comprises (d) one or more biocides, wherein said biocides are selected from zinc pyrithione, copper pyrithione, zinc-ethylenebis(dithiocarbamate) (Zineb), and 4,5-dichloro-2-n-octyl-4-isothiazolin-3-one (DCOIT, Sea-Nine® 211N); and wherein said biocides are present in an amount of 5-15% by dry weight, e.g. 8-13% by dry weight, in particular 7-12% by dry weight.

In one embodiment, said antifouling coating composition further comprises (d) one or more biocides, wherein said biocides are selected from zinc pyrithione, copper pyrithione, zinc-ethylenebis(dithiocarbamate) (Zineb), and 4,5-dichloro-2-n-octyl-4-isothiazolin-3-one (DCOIT, Sea-Nine® 211N); and wherein said biocides are present in an amount of 0-15% by volume solids, preferably 5-15% volume solids, even more preferably 5-10% volume solids.

In one embodiment, said antifouling coating composition further comprises (e) piperidine derivatives, wherein said piperidine derivatives are selected from 2,2,6,6-tetraalkyl piperidine derivatives, more preferably 2,2,6,6-tetramethyl piperidine derivatives, even more preferably bis[2,2,6,6-tetramethyl-1-(octyloxy)piperidin-4-yl]decanedioate and wherein said piperidine derivative is present in an amount of 0.05-10%, such as 0.08-8%, or such as 0.1-7%, such as 0.12-5%, in particular 0.15-3%, by dry weight of said coat (or coating composition).

In one embodiment, said antifouling coating composition further comprises (e) piperidine derivatives, wherein said piperidine derivatives are selected from 2,2,6,6-tetraalkyl piperidine derivatives, more preferably 2,2,6,6-tetramethyl piperidine derivatives, even more preferably bis[2,2,6,6-tetramethyl-1-(octyloxy)piperidin-4-yl]decanedioate and wherein said piperidine derivative is present in an amount of 0.06-11.9% by volume solids, such as 0.1-9.8%, or such as 0.13-8.5%, such as 0.16-6.1%, in particular 0.18-3.7% volume solids of the coating composition.

In one embodiment, said antifouling coating composition further comprises
f) one or more pigments
g) one or more additives, such as wetting agents, thickening agent and thixotropic agents
h) one or more fillers

Another embodiment provides a non-erodible antifouling coat, said antifouling coat comprising:
a) 45-85% solids volume of an alkyl (meth)acrylate polymer
b) 5-30%, such as 5-25% by volume solids of a non-reactive polyoxyalkylene-modified silicone oil
c) optionally, one or more biocides, as defined herein, and
d) optionally, one or more sterically hindered amines as defined herein.

A further embodiment provides a non-erodible antifouling coat, said antifouling coat comprising:
a) 15-75% by dry weight of an alkyl (meth)acrylate polymer
b) 3-25% by dry weight of a non-reactive polyoxyalkylene-modified silicone oil
c) optionally, one or more biocides, as defined herein, and
d) optionally, one or more sterically hindered amines as defined herein.

### Antifouling Coat

A further aspect of the present invention is an antifouling coat (occasionally referred to as a “paint coat” or a “coating”) corresponding to the antifouling coating composition. The constituents are as defined further above for the coating composition, and any descriptions, preferences and variants also apply for the coat which simply represents the coating composition when allowed to dry.

The non-erodible antifouling coat of the invention comprises:
a. an acrylate polymer as defined herein;
b. one or more non-reactive polyoxyalkylene-modified silicone oils as defined herein
c. optionally, one or more biocides, as defined herein and
d. optionally, one or more sterically hindered amines as defined herein

The amounts of the various components a-d are as set out above for the coating composition, compensating for removal of the solvent(s).

The polishing of the non-erodible antifouling coat is preferably not more than 0.5 μm/10.000 Nautical miles, preferably 0 μm/10.000 Nautical miles, according to the Lab rotor Polishing Rate Test defined herein.

### Preparation of the Coating Composition

The coating compositions may be prepared by any suitable technique that is commonly used within the field of paint production. Thus, the various constituents may be mixed together utilizing a mixer, a high-speed disperser, a ball mill, a pearl mill, a grinder, a three-roll mill etc. The coating compositions are typically prepared and shipped as one or two-component systems that should be combined and thoroughly mixed immediately prior to use. The paints according to the invention may be filtrated using bag filters, patron filters, wire gap filters, wedge wire filters, metal edge filters, EGLM turnoclean filters (ex. Cuno), DELTA strain filters (ex. Cuno), and Jenag Strainer filters (ex. Jenag), or by vibration filtration. Suitable preparation methods are described in the examples.

### Application of the Coating Composition

The antifouling coating composition is used to prepare a corresponding antifouling coat, A method is provided for coating a substrate, said method comprising applying the acrylate coating composition as defined herein to said substrate and allowing the composition to dry.

The coating composition of the invention is typically applied to at least a part of the surface of a substrate.

The term “applying” is used in its normal meaning within the paint industry. Thus, “applying” is conducted by means of any conventional means, e.g. by brush, by roller, by spraying, by dipping, etc. The commercially most interesting way of “applying” the coating composition is by spraying. Hence, the coating composition is preferably sprayable. Spraying is effected by means of conventional spraying equipment known to the person skilled in the art. The coating is typically applied in a dry film thickness of 50-600 μm, such as 50-500 μm, e.g. 75-400 μm, or 20-150 μm, or 30-100 μm.

Moreover, the coating composition is preferably such with respect to sag resistance cf. ASTM D 4400-99 (i.e. relating to its ability to be applied in a suitable film thickness to a vertical surface without sagging) that it exhibits sag resistance for a wet film thickness up to at least 70 μm, such as up to at least 200 μm, e.g. up to at least 300 μm, preferably up to at least 400 μm, and in particular up to at least 600 μm.

The term “at least a part of the surface of a substrate” refers to the fact that the coating composition may be applied to any fraction of the surface. For many applications, the coating composition is at least applied to the part of the substrate (e.g. a vessel) where the surface (e.g. the ship's hull) may come in contact with water, e.g. sea-water.

The term “substrate” is intended to mean a solid material onto which the coating composition is applied. The substrate typically comprises a metal such as steel, iron, aluminium, or glass-fibre reinforced polyester. In the most interesting embodiments, the substrate is a metal substrate, in particular a steel substrate. In an alternative embodiment, the substrate is a glass-fibre reinforced polyester substrate. In some embodiments, the substrate is at least a part of the outermost surface of a marine structure.

The term “surface” is used in its normal sense and refers to the exterior boundary of an object. Particular examples of such surfaces are the surface of marine structures, such as vessels (including but not limited to boats, yachts, motorboats, motor launches, ocean liners, tugboats, tankers, container ships and other cargo ships, submarines, and naval vessels of all types), pipes, shore and off-shore machinery, constructions and objects of all types such as piers, pilings, bridge substructures, floatation devices, water-power installations and structures, underwater oil well structures, nets and other aquatic culture installations, cooling plants, and buoys, etc., and is especially applicable to the hulls of ships and boats and to pipes. Particularly, the surface is a surface of a yacht.

The surface of the substrate may either be the “native” surface (e.g. a steel substrate or a composite substrate, such as a glass fibre-reinforced polymer substrate). However, the substrate is typically coated, e.g. with an anticorrosive coating and/or a tie coat, so that the surface of the substrate is constituted by such a coating. When present, the (anticorrosive and/or tie) coating is typically applied in a total dry film thickness of 100-600 μm, such as 150-450 μm, e.g. 200-400 μm. Alternatively, the substrate may carry a paint coat, e.g. a worn-out antifouling paint coat, or similar.

In one important embodiment, the substrate is a glass-fiber reinforced polyester substrate optionally coated with an epoxy primer coating.

The coating composition is typically applied as the outermost coat (a.k.a. a top-coat), i.e. the coat being exposed to the environment, e.g. an aquatic environment. However, it should be understood that the coating composition alternatively may be applied as a layered system where the coating composition will be coated with one or more layer(s) of one or more other coating compositions in order to obtain an improved control of the leaching rate of the leachable components in the coat.

Prior to the application of a coating composition to a marine structure, the marine structure may first be coated with a primer-system which may comprise several layers and may be any of the conventional primer systems used in connection with application of coating compositions to marine structures. Thus, the primer system may include an anti-corrosive primer optionally followed by a layer of an adhesion-promoting primer.

In some variants of the above-mentioned method, the antifouling coat may be further coated with a top-coat.

### A Substrate

Furthermore, a substrate is provided, being coated on at least one surface thereof with an antifouling coat according to the invention. In particular, the surface carrying the antifouling coat is a submerged surface of said substrate. In a preferred aspect, the substrate is the hull of a yacht.

A multilayer antifouling coat system is also provided, said system comprising at least two paint coats, at least one of said paint coats being the non-erodible antifouling coat according to the invention.

The coating composition, the method of establishing the coating on the substrate surface, and the characteristics of the coating follow the directions given hereinabove.

In one embodiment, the antifouling coating system of the marine structure may consist of an anticorrosive layer and the antifouling coating system as described herein.

In an alternative embodiment, the antifouling coating composition is applied on top of a used antifouling coating system, e.g. on top of a used antifouling coat.

In one particular embodiment of the above marine structure, the anticorrosive layer has a total dry film thickness of 100-600 μm, such as 150-450 μm, e.g. 200-400 μm; and the antifouling coating has a total dry film thickness of 20-500 μm, such as 20-400 μm, e.g. 50-300 μm.

A further embodiment of the marine structure is that where at least a part of the outermost surface of said structure is coated with an antifouling coating system comprising a total dry film thickness of 150-400 μm of an anticorrosive layer of an epoxy-based coating established by application of 1-4, such as 2-4, layers; and a total dry film thickness of 20-400 μm of the antifouling coat established by application of 1-2 layers of the coating composition as defined hereinabove.

### General Remarks

Although the present description and claims occasionally refer to a binder, a biocide, etc., it should be understood that the coating compositions defined herein may comprise one, two or more types of the individual constituents. In such embodiments, the total amount of the respective constituent should correspond to the amount defined above for the individual constituent.

The “(s)” in the expressions: compound(s), silicones(s), agent(s), etc. indicates that one, two or more types of the individual constituents may be present.

On the other hand, when the expression “one” is used, only one (1) of the respective constituents is present.

It should be understood that when reference is made to the coating composition, it is the mixed coating composition. Furthermore, all amounts stated as % by solids volume of the coating should be understood as % by solids volume of the mixed coating composition (or the final coat) unless stated otherwise.

It should be understood that the expression “% dry weight” means the percentage of the respective component based on the dry weight of the coat or of the coating composition, as the case may be. For most practical purposes (hence, unless otherwise stated), the “% dry weight” when referring the final coat is identical to the “% dry weight” of the coating composition.

### Determination of HLB Value

The HLB (hydrophilic-lipophilic balance) value for a polyoxyalkylene-modified silicone oil is determined according to Griffin's method:

HLB value=20*Mₕ/M

wherein Mₕ is the weight of the hydrophilic (polyoxyalkylene) group(s) in the molecule, and wherein M is the weight of the whole molecule.

### Preparation of Coating Compositions for Test Examples

The coating compositions are prepared following the standard procedure. An initial dispersion of the components of the binder in organic solvent, followed by addition of part or all the additives such as thixotropic agents, etc., and eventually the addition of part or all the pigments such as zinc oxide, fibres, etc. are mixed on a Diaf dissolver equipped with an impeller disc. Further, the rest of the pigments such as cuprous oxide, zinc-ethylenebis(dithiocarbamate) (Zineb) is added, and a temperature activation of any component that may require it (e.g. thixotropic agent) is initiated. The coating compositions are finally let down with the remaining additives and binders, and its rheology adjusted with final addition of remaining organic solvent.

Typically, the solid components of the coating composition are mixed and ground. The polyoxyalkylene-modified siloxanes oils may alternatively be added in initial or later additive addition step.

The coating composition is typically prepared as a one component paint (also called a “one pot” coating composition).

It should be understood that the expression “% dry weight” means the percentage of the respective component based on the dry weight of the coat or of the coating composition, as the case may be. For most practical purposes (hence, unless otherwise stated), the “% dry weight” when referring the cured coat is identical to the “% dry weight” of the coating composition.

### Methods

### Polishing Rate Test

### Lab Rotor Polishing Test

Polishing and leaching characteristics are measured using a rotary set-up similar to the one described by Kiil et al. (Kiil, S, Weinell, C E, Yebra, D M, Dam-Johansen, K, “Marine biofouling protection: design of controlled release antifouling paints.” In: Ng, K M, Gani, R, Dam-Johansen, K (eds.) Chemical Product Design; Towards a Perspective Through Case Studies, 23IDBN-13: 978-0-444-52217-7. Part II (7), Elsevier (2006)). The set-up consists of a rotary rig, which has two concentric cylinders with the inner cylinder (rotor, diameter of 0.3 m and height 0.17 m) capable of rotation. The cylinder pair is immersed in a tank containing about 400-500 litres of Artificial Seawater (cf. Table 1).

TABLE 1
Composition of Artificial Seawater

| Salt | Concentration in g/L |
|---|---|
| NaCl | 32 |
| MgSO₄•7H₂O | 14 |
| NaHCO₃ | 0.2 |

The tank is fitted with baffles to break the liquid flow, which enhances turbulence and enables faster mixing of the species released from the paints and enhance heat transfer from a thermostating system. The purpose of using two cylinders is to create a close approximation to couette flow (flow between two parallel walls, where one wall moves at a constant velocity). The rotor is operated at 20 knots at 25° C. (unless otherwise specified), and the pH is adjusted frequently to 8.2 using 1 M sodium hydroxide or 1 M hydrochloric acid.

Samples are prepared using overhead transparencies (3M PP2410) that are primed using two-component paint (Hempadur 47182 ex Hempel A/S) applied using a Doctor Blade applicator with a gap size of 200 μm. Coating samples are applied adjacent to each other using a Doctor Blade applicator with a gap of 250 μm. After drying for 1 day, the coated transparency is cut in strips of 2 cm resulting in eight samples of 1.5×2 cm² on a long (21 cm) strip. The strips are mounted on the rotor, and left to dry for a week.

After one week, the test is initiated, and during the experiment, samples are removed after 35, 65 and 140 days in order to inspect the polishing and leaching depths. The samples are dried for three days at ambient conditions, after which they are cut in half and cast in paraffin. The internal front of the sample is planed off before total film thickness and leached layer thickness is established using light microscopy (coating cross-section inspection).

### Sea Rotor Polishing Test

A stainless-steel test panel (13.5×7 cm) with a curvature corresponding to that of a cylindrical drum with a diameter of 1 m is first coated with 40-50 μm (DFT) of an epoxy primer (Hempadur 15553 ex Hempel A/S). After 24 hours, the panel is coated with 80 μm (DFT) of a commercial epoxy tie coat (HEMPADUR 49183 ex Hempel A/S) applied by air spraying.

After minimum 24 hours drying in the laboratory at room temperature the test paint is applied by air spraying in a DFT of approximately 150-200 μm. The panel is dried for at least 1 week in the laboratory at room temperature before testing. The initial thickness of the paint system is measured using a coating thickness tester (Isoscope, Fischer).

The test panel is fixed onto the convex surface of a cylindrical drum of 1 m in diameter and is rotated in sea water with a salinity in the range of 37-38 parts per thousand at an average temperature of 17-18° C. at a test site in Vilanova i la Geltrú in Northeastern Spain, which is situated at latitude 41.13 North and longitude 1.43 East.

### EXAMPLES

### Materials

### Binders

Neocryl B842 ex. DSM. BMA copolymer with average mol weight 110.000 and Tg=47° C.

Neocryl B-725 ex. DSM. MMA/BMA copolymer with average mol weight 55.000 and Tg=63° C.

Degalan LP64/12 ex. Rohm. MMA/BMA copolymer with average mol weight 55.000 and Tg=63° C.

Degalan LP65/11 ex. Rohm. MMA/BMA copolymer with average mol weight 35.000 and Tg=51° C.

Degalan LP63/11 ex. Rohm. MMA/BMA copolymer with average mol weight 30.000 and Tg=44° C.

Degalan LP65/12 ex. Rohm. MMA/BMA copolymer with average mol weight 60.000 and Tg=57° C.

Degalan P24 ex. Rohm. BMA copolymer with average mol weight 180.000 and Tg=43° C.

BA123 ex. LGMMA. BMA copolymer with average mol weight 60.000 and Tg=60° C.

Elvacite 2044 ex. Mitsubishi Chemical. BMA copolymer with average mol weight 200.000 and Tg=20° C.

Elvacite 2045 ex. Mitsubishi Chemical. BMA copolymer with average mol weight 260.000 and Tg=48° C.

Elvacite 2016 ex. Mitsubishi Chemical. MMA/BMA copolymer with average mol weight 55.000 and Tg=50° C.

Acrylamide; Eterac 7257—BR-50 Ex Eternal (Taiwan)

Hydrocarbon; Novares TT 110 ex. Rutgers. Hydrocarbon resin; polymerisation product from unsaturated aromatic C9-/C10 hydrocarbons.

Chinese Gum Rosin ex Arawaka Chemical Industries (China)

NSP-100 ex Nitto Kasei (Japan), 50 wt. % solution xylene/ethykbenzene (1:1), Silylated acrylic copolymer binder solution

NAD core/shell acrylic copolymer ex Dai Nippon Toryo Co, Ltd (Japan)

### Polyoxyalkylene-Modified Silicone Oils

BYK-330 ex BYK (Germany)

BYK-333 ex BYK (Germany)

BYK-378 ex BYK (Germany)

BYK-3560 ex BYK (Germany)

BYK-3565 ex BYK (Germany)

BYK-3566 ex BYK (Germany)

BYK-3760 ex BYK (Germany)

KF-6020 ex Shin-Etsu (Japan)

PDMS—silicone oil

X-22-2516 ex Shin-Etsu (Japan)

KF-6015 ex Shin-Etsu (Japan)

KF-353 ex Shin-Etsu (Japan)

KF-6011 ex Shin-Etsu (Japan)

KF-643 ex Shin-Etsu (Japan)

KF-354L ex Shin-Etsu (Japan)

KF-6020 ex Shin-Etsu (Japan)

SilClean 3710 ex BYK (Germany)

Commercial polyoxyalkylene-modified silicone oil with a MW about 4000 Da and an HLB about 8.6

Commercial polyoxyalkylene-modified silicone oil with a MW about 10000 Da and an HLB about 4.0

Polyethylene glycol (PEG) Mn550 ex SigmaAldrich

Polyethylene glycol/polypropylene glycol (PPG/PEG/PPG) Mn3300 ex SigmaAldrich

### Biocides

Zinc pyrithione ex Lonza

Copper pyrithione ex Lonza SeaNine Ultra ex Lanxess

SeaNine 211N ex Lanxess

Zineb ex UPL

Nordox cuprous oxide paint grade ex Nordox (Norway)

### Sterically Hindered Amine

Tinuvin 123 ex BASF (Germany)

Other ingredients (plasticizers, pigments, additives, solvents, fillers) were obtained from standard commercial suppliers.

### Antifouling Property Test

An acrylic test panel (15×20 cm²), sandblasted on one side to facilitate adhesion of the coating, is first coated with 80 μm (DFT) of a commercial chlorinated rubber primer (Hempatex 46330 ex Hempel) applied by air spraying. After a minimum drying time of 24 hours in the laboratory at room temperature the test paint is applied with a Doctor Blade type applicator, with four gap sizes with a film width of 80 mm. One coat was applied in a DFT of 90-100 μm. After at least 72 hours drying the test panels are fixed on a rack and immersed in sea water.

### Test at Vilanova i la Geltrú in Northeastern Spain

In this test site the panels are immersed in seawater with salinity in the range of 37-38 parts per thousand at an average temperature in the range of 17-18° C. Every 1-12 weeks, inspection of the panels is made and the antifouling performance is evaluated according to the scale shown in Table 2. One score is given for the total fouling of the types: algae and animals.

### Test at Singapore

In this test site the panels are immersed in seawater with salinity in the range of 29-31 parts per thousand at a temperature in the range of 29-31° C. Every 1-12 weeks, inspection of the panels is made and the antifouling performance is evaluated according to the scale shown in Table 2. One score is given for the total fouling of the types: algae and animals.

TABLE 2
Scale for grading the performance of coatings
undergoing static antifouling testing

| Score | Fouled area (%) |
|---|---|
| Excellent | Only slime |
| Good | Algae + Animals < 10% |
| Fair | 10% < Algae + Animals < 25% |
| Poor | Algae + Animals > 25% |

### Coating Compositions and Results

### Example 1

Antifouling coating compositions comprising an alkyl acrylate binder copolymer of MMA/BMA is prepared together with a polyoxyalkylene-modified silicone oil and further addition of a biocide. The compositions were subjected to an antifouling property test on a raft in Spain for 47 weeks.

| | Component | | | | | | |
|---|---|---|---|---|---|---|---|
| | properties | | | | | | |
| Model | (% by weight/ | | | | | | |
| paint | % volume | Ex. 1.1 | | Ex. 1.2 | | Ex. 1.3 | |
| Component | solids) | % wt | % VS | % wt | % VS | % wt | % VS |
| Acrylic | MW = | 31 | 85.2 | 29.7 | 75.5 | 28.5 | 70.6 |
| binder | 50-65.000, | | | | | | |
| (MMA/BMA | Tg = | | | | | | |
| copolymer) | 60-63° C. | | | | | | |
| polyoxy- | polyoxy- | 0 | 0 | 4.1 | 11.2 | 4.3 | 11.4 |
| alkylene- | alkylene- | | | | | | |
| modified | modified | | | | | | |
| silicone oil | silicone oil | | | | | | |
| | (HLB = 8.6) | | | | | | |
| plasticizer | | 2.3 | 6.3 | 2.3 | 5.6 | 2.2 | 5.2 |
| pigments | | 2 | 3.3 | 1.9 | 3.0 | 1.8 | 2.8 |
| additives | Thixotropic | 2.5 | 5.2 | 2.5 | 4.7 | 2.4 | 4.4 |
| | agents, | | | | | | |
| | wetting | | | | | | |
| | agents | | | | | | |
| solvents | Xylene, | 62.2 | 0 | 59.5 | 0 | 57.1 | 0 |
| | naphta, | | | | | | |
| | alcohol | | | | | | |
| Biocides | Zinc pyrithione | 0 | 0 | 0 | 0 | 3.7 | 5.6 |
| | Copper | | | | | | |
| | pyrithione | | | | | | |
| Total | | 100 | 100 | 100 | 100 | 100 | 100 |

| | | | |
|---|---|---|---|
| Performance | Poor | Fair | Good |
| on raft in | | | |
| Spain after | | | |
| 47 weeks | | | |

The results show that antifouling coating compositions comprising a polyoxyalkylene-modified silicone oil have improved antifouling performance compared to a composition without the silicone oil. The performance is further improved when a biocide is added to the composition.

### Example 2

Antifouling coating compositions comprising an alkyl acrylate binder copolymer of MMA/BMA is prepared together with different levels of a polyoxyalkylene-modified silicone oil. The compositions were subjected to an antifouling property test on a raft in Spain for 12 and 16 weeks.

| | Component | | | | | | | | | | | | |
|---|---|---|---|---|---|---|---|---|---|---|---|---|---|
| | properties | | | | | | | | | | | | |
| Model | (% by weight/ | | | | | | | | | | | | |
| paint | % volume | Ex. 2.1 | | Ex. 2.2 | | Ex. 2.3 | | Ex. 2.4 | | Ex. 2.5 | | Ex. 2.6 | |
| Component | solids) | % wt | % VS | % wt | % VS | % wt | % VS | % wt | % VS | % wt | % VS | % wt | % VS |
| Acrylic | MW = | 31.5 | 86.5 | 22.2 | 66.1 | 21.8 | 62.4 | 21.3 | 58.7 | 20.8 | 55.0 | 19.8 | 504 |
| binder | 50-65.000, | | | | | | | | | | | | |
| (MMA/BMA | Tg = | | | | | | | | | | | | |
| copolymer) | 60-63° C. | | | | | | | | | | | | |
| polyoxy- | polyoxy- | 0 | 0 | 1.6 | 5.0 | 3.2 | 10.0 | 5.1 | 15.0 | 7.0 | 20.0 | 9.4 | 25.8 |
| alkylene- | alkylene- | | | | | | | | | | | | |
| modified | modified | | | | | | | | | | | | |
| silicone oil | silicone oil | | | | | | | | | | | | |
| | (HLB = 8.6) | | | | | | | | | | | | |
| Sterically | Tinuvin 123 | 0 | 0 | 1.5 | 5.2 | 1.6 | 5.2 | 1.7 | 5.2 | 1.7 | 5.2 | 1.8 | 5.2 |
| hindered | | | | | | | | | | | | | |
| amine | | | | | | | | | | | | | |
| plasticizer | | 2.4 | 6.3 | 1.6 | 4.6 | 1.6 | 4.4 | 1.5 | 4.1 | 1.5 | 3.9 | 1.5 | 3.8 |
| pigments | | 0 | 0 | 16.3 | 13.2 | 16.0 | 12.4 | 15.6 | 11.7 | 15.3 | 11.0 | 16.1 | 11.1 |
| additives | Thixotropic | 2.8 | 5.6 | 2.9 | 5.9 | 2.8 | 5.6 | 2.8 | 5.3 | 2.7 | 5.0 | 2.1 | 3.7 |
| | agents, | | | | | | | | | | | | |
| | wetting | | | | | | | | | | | | |
| | agents | | | | | | | | | | | | |
| solvents | Xylene, | 61.8 | 0 | 53.9 | 0 | 53.0 | 0 | 52.0 | 0 | 51.0 | 0 | 49.3 | 0 |
| | naphta, | | | | | | | | | | | | |
| | alcohol | | | | | | | | | | | | |
| Fillers | Calcium | 1.4 | 1.6 | 0 | 0 | 0 | 0 | 0 | 0 | 0 | 0 | 0 | 0 |
| | carbonate | | | | | | | | | | | | |
| Total | | 100 | 100 | 100 | 100 | 100 | 100 | 100 | 100 | 100 | 100 | 100 | 100 |

| | | | | | | |
|---|---|---|---|---|---|---|
| Performance | Poor | Fair | Excellent | Excellent | Excellent | Excellent |
| on raft in | | | | | | |
| Spain after | | | | | | |
| 12 weeks | | | | | | |
| Performance | Poor | Poor | Fair | Good | Good | Good |
| on raft in | | | | | | |
| Spain after | | | | | | |
| 16 weeks | | | | | | |

The results show that antifouling coating compositions comprising a polyoxyalkylene-modified silicone oil in an amount of 3% weight/10%-VS, or higher, has improved antifouling performance than the compositions with less than 3% weight/10%-VS or without the silicone oil.

### Example 3

Antifouling coating compositions comprising an alkyl acrylate binder copolymer of MMA/BMA is prepared together with different polyoxyalkylene-modified silicone oils. Further to this composition, a sterically hindered amine was added at two different levels (1%-VS and 5%-VS). The compositions were subjected to an antifouling property test on a raft in Spain for 4 weeks.

| | Component | | | | | | | | | | | | | | |
|---|---|---|---|---|---|---|---|---|---|---|---|---|---|---|---|
| Model | properties | | | | | | | | | | | | | | |
| Paint | (% by weight/ | | | | | | | | | | | | | | |
| example | % volume | Example 3.1 | | Example 3.2 | | Example 3.3 | | Example 3.4 | | Example 3.5 | | Example 3.6 | | Example 3.7 | |
| Component | solids) | % wt | % VS | % wt | % VS | % wt | % VS | % wt | % VS | % wt | % VS | % wt | % VS | % wt | % VS |
| Acrylic | MW = | 29.9 | 84.5 | 28.9 | 76.0 | 28.8 | 75.2 | 28.3 | 71.8 | 28.9 | 76.0 | 28.8 | 75.2 | 28.4 | 71.8 |
| binder | 50-65.000, | | | | | | | | | | | | | | |
| (MMA/BMA | Tg = | | | | | | | | | | | | | | |
| copolymer) | 60-63° C. | | | | | | | | | | | | | | |
| Polyoxy- | HLB = 8.6 | 0 | 0 | 3.5 | 10.0 | 3.6 | 10.0 | 3.7 | 10.0 | 0 | 10.0 | 0 | 0 | 0 | 0 |
| alkylene- | HLB = 4.0 | 0 | 0 | 0 | 0 | 0 | 0 | | 0 | 3.5 | 10.0 | 3.5 | 10.0 | 3.6 | 10.0 |
| modified | | | | | | | | | | | | | | | |
| silicone oil | | | | | | | | | | | | | | | |
| Sterically | Tinuvin 123 | 0 | 0 | 0 | 0 | 0.3 | 1.0 | 1.7 | 5.0 | 0 | 0 | 0.3 | 1.0 | 1.7 | 5.0 |
| hindered | | | | | | | | | | | | | | | |
| amine | | | | | | | | | | | | | | | |
| Plasticizer | | 2.3 | 6.3 | 2.2 | 5.7 | 2.2 | 5.6 | 2.2 | 5.3 | 2.2 | 5.7 | 2.2 | 5.6 | 2.2 | 5.3 |
| Pigments | | 4.7 | 3.7 | 4.5 | 3.3 | 4.5 | 3.3 | 4.5 | 3.2 | 4.5 | 3.3 | 4.5 | 3.3 | 4.5 | 3.2 |
| Additives | Thixotropic | 2.8 | 5.5 | 2.7 | 5.0 | 2.6 | 4.9 | 2.6 | 4.7 | 2.7 | 5.0 | 2.6 | 4.9 | 2.6 | 4.7 |
| | agents, | | | | | | | | | | | | | | |
| | wetting | | | | | | | | | | | | | | |
| | agents | | | | | | | | | | | | | | |
| Solvents | Xylene, | 60.3 | 0 | 58.2 | 0 | 58.0 | 0 | 57.0 | 0 | 58.2 | 0 | 58.0 | 0 | 57.1 | 0 |
| | naphta, | | | | | | | | | | | | | | |
| | alcohol | | | | | | | | | | | | | | |
| Total | | 100 | 100 | 100 | 100 | 100 | 100 | 100 | 100 | 100 | 100 | 100 | 100 | 100 | 100 |

| | | | | | | | |
|---|---|---|---|---|---|---|---|
| Performance | Poor | Fair | Fair | Fair | Fair | Good | Fair |
| on raft in | | | | | | | |
| Spain after | | | | | | | |
| 4 weeks | | | | | | | |

The results show that antifouling coating compositions comprising a polyoxyalkylene-modified silicone oil alone performs better than compositions without the oil. Examples 3.6 show that the further addition of a sterically hindered amine in an amount of 1%-VS improves the performance. When the level of the sterically hindered amine reaches 5%-VS, the effect of the amine on the performance drops.

### Example 4

Antifouling coating compositions comprising different types of binders are prepared together with a polyoxyalkylene-modified silicone oil. The compositions were subjected to an antifouling property test on a raft in Spain for 10 weeks.

| | Component | | | | | | | | | | |
|---|---|---|---|---|---|---|---|---|---|---|---|
| Model | properties | | | | | | | | | | |
| Paint | (% by weight/ | | | | | | | | | | |
| example | % volume | Example 4.1 | | Example 4.2 | | Example 4.3 | | Example 4.4 | | Example 4.5 | |
| Component | solids) | % wt | % VS | % wt | % VS | % wt | % VS | % wt | % VS | % wt | % VS |
| Acrylic | MW = | 47.6 | 90 | | | | | | | 50.0 | 100 |
| binder | 50-65.000, | | | | | | | | | | |
| (MMA/BMA | Tg = | | | | | | | | | | |
| copolymer) | 60-63° C. | | | | | | | | | | |
| Acrylic | MW 110.000, | | | 47.1 | 90 | | | | | | |
| (BMA) | Tg = 47° C. | | | | | | | | | | |
| Acrylamide | | | | | | 47.6 | 90 | | | | |
| Alkylaromatic | | | | | | | | 47.1 | 90 | | |
| hydrocarbon | | | | | | | | | | | |
| resin | | | | | | | | | | | |
| Polyoxy- | HLB = 8.6 | 4.9 | 10 | 4.9 | 10 | 4.7 | 10 | 4.9 | 10 | 0 | |
| alkylene- | | | | | | | | | | | |
| modified | | | | | | | | | | | |
| silicone oil | | | | | | | | | | | |
| Solvents | | 47.6 | | 48.0 | | 47.6 | | 48 | | 50.0 | |
| Total | | 100 | 100 | 100 | 100 | 100 | 100 | 100 | 100 | 100 | 100 |

| | | | | | |
|---|---|---|---|---|---|
| Performance | Fair | Good | Poor | Poor | Poor |
| on raft in | | | | | |
| Spain after | | | | | |
| 10 weeks | | | | | |

The results show that binders of the acrylic type, such as a copolymer of MMA/BMA or homopolymer of BMA, have better antifouling properties than other binder types. Example 4.5 is a comparative example, which includes only the binder, in which the polyoxyalkylene-modified silicone oil is omitted.

### Example 5

Antifouling coating compositions comprising an alkyl acrylate binder copolymer of MMA/BMA is prepared together with a polyoxyalkylene-modified silicone oil and a sterically hindered amine or a polyoxyalkylene-modified silicone oil and a biocide. The compositions were subjected to an antifouling property test on a raft in Spain for 11 weeks and in Singapore for 8 weeks.

| | Component | | | | | | |
|---|---|---|---|---|---|---|---|
| Model | properties | | | | | | |
| Paint | (% by weight/ | | | | | | |
| example | % volume | Example 5.1 | | Example 5.2 | | Example 5.3 | |
| Component | solids) | % wt | % VS | % wt | % VS | % wt | % VS |
| Acrylic | MW = | 26.1 | 77.7 | 24.5 | 64.3 | 23.8 | 62.4 |
| binder | 50-65.000, | | | | | | |
| (MMA/BMA | Tg = | | | | | | |
| copolymer) | 60-63° C. | | | | | | |
| Polyoxy- | HLB = 8.6 | 0 | 0 | 4.0 | 11.3 | 4.0 | 11.3 |
| alkylene- | | | | | | | |
| modified | | | | | | | |
| silicone oil | | | | | | | |
| Sterically | Tinuvin 123 | 0 | 0 | 2.0 | 5.9 | 0 | 0 |
| hindered | | | | | | | |
| amine | | | | | | | |
| Biocide | Zinc pyrithione | 0 | 0 | 0 | 0 | 5.0 | 8.2 |
| Plasticizer | | 2 | 5.9 | 1.9 | 4.9 | 1.8 | 4.7 |
| Pigments | | 10.2 | 8.3 | 9.6 | 6.9 | 9.3 | 6.7 |
| Additives | Thixotropic | 2.6 | 5.6 | 2.4 | 4.7 | 2.4 | 4.7 |
| | agents, | | | | | | |
| | wetting | | | | | | |
| | agents | | | | | | |
| Solvents | Xylene, | 57.1 | 0 | 53.7 | 0 | 52.0 | 0 |
| | naphta, | | | | | | |
| | alcohol | | | | | | |
| Filler | calcium | 2 | 2.5 | 1.9 | 2 | 1.8 | 2 |
| | carbonate | | | | | | |
| Total | | 100 | 100 | 100 | 100 | 100 | 100 |

| | | | |
|---|---|---|---|
| Performance | Poor | Fair | Excellent |
| on raft in | | | |
| Spain after | | | |
| 11 weeks | | | |
| Performance | Poor | Fair | Excellent |
| on raft in | | | |
| Singapore | | | |
| after | | | |
| 8 weeks | | | |

The results show that antifouling coating compositions comprising a polyoxyalkylene-modified silicone oil and a sterically hindered amine has improved antifouling performance compared to a composition without the silicone oil and sterically hindered amine. Also, a composition comprising a polyoxyalkylene-modified silicone oil and a biocide has improved antifouling performance compared to a composition without the silicone oil and biocide.

### Example 6

Antifouling compositions comprising different types of biocides are prepared with an acrylic binder (MMA/BMA) and a polyoxyalkylene-modified silicone oil. The compositions were subjected to an antifouling property test on a raft in Spain for 12 and 24 weeks.

| | Component | | | | | | | | | | | | | | |
|---|---|---|---|---|---|---|---|---|---|---|---|---|---|---|---|
| Model | properties | | | | | | | | | | | | | | |
| Paint | (% by weight/ | | | | | | | | | | | | | | |
| example | % volume | Example 6.1 | | Example 6.2 | | Example 6.3 | | Example 6.4 | | Example 6.5 | | Example 6.6 | | Example 6.7 | |
| Component | solids) | % wt | % VS | % wt | % VS | % wt | % VS | % wt | % VS | % wt | % VS | % wt | % VS | % wt | % VS |
| Acrylic | MW = | 50 | 100 | 48.2 | 92.5 | 44.7 | 84.5 | 44.7 | 84.5 | 45.5 | 84.5 | 41.6 | 84.5 | 44.4 | 84.5 |
| binder | 50-65.000, | | | | | | | | | | | | | | |
| (MMA/BMA | Tg = | | | | | | | | | | | | | | |
| copolymer) | 60-63° C. | | | | | | | | | | | | | | |
| Polyoxy- | HLB = 8.6 | 0 | 0 | 3.6 | 7.5 | 3.7 | 7.5 | 3.7 | 7.5 | 3.7 | 7.5 | 3.4 | 7.5 | 3.7 | 7.5 |
| alkylene- | | | | | | | | | | | | | | | |
| modified | | | | | | | | | | | | | | | |
| silicone oil | | | | | | | | | | | | | | | |
| Biocide | Zinc | 0 | 0 | 0 | 0 | 6.9 | 8.0 | 0 | 0 | 0 | 0 | 0 | 0 | 0 | 0 |
| | pyrithione | | | | | | | | | | | | | | |
| | Copper | 0 | 0 | 0 | 0 | 0 | 0 | 7.0 | 8.0 | 0 | 0 | 0 | 0 | 0 | 0 |
| | pyrithione | | | | | | | | | | | | | | |
| | SeaNine | 0 | 0 | 0 | 0 | 0 | 0 | 0 | 0 | 5.2 | 8.0 | 0 | 0 | 0 | 0 |
| | (encapsulated) | | | | | | | | | | | | | | |
| | SeaNine 211 | 0 | 0 | 0 | 0 | 0 | 0 | 0 | 0 | 0 | 0 | 13.4 | 8.0 | 0 | 0 |
| | Zineb | 0 | 0 | 0 | 0 | 0 | 0 | 0 | 0 | 0 | 0 | 0 | 0 | 7.5 | 8.0 |
| Solvents | Xylene, | 50 | 0 | 48.2 | 0 | 44.7 | 0 | 44.7 | 0 | 45.5 | 0 | 41.6 | 0 | 44.4 | 0 |
| | naphta, | | | | | | | | | | | | | | |
| | alcohol | | | | | | | | | | | | | | |
| Total | | 100 | 100 | 100 | 100 | 100 | 100 | 100 | 100 | 100 | 100 | 100 | 100 | 100 | 100 |

| | | | | | | | |
|---|---|---|---|---|---|---|---|
| Performance | Poor | Fair | Good | Fair | Fair | Good | Good |
| on raft in | | | | | | | |
| Spain after | | | | | | | |
| 12 weeks | | | | | | | |
| Performance | Poor | Poor | Fair | Poor | Poor | Fair | Fair |
| on raft in | | | | | | | |
| Spain after | | | | | | | |
| 24 weeks | | | | | | | |

If added, each of the compositions are formulated with 7.5% volume solids of the polyoxyalkylene-modified silicone oil and 8% volume solids of the biocide.

The results show that the acrylic binder alone performs poor. Addition of 7.5% VS of the polyoxyalkylene-modified silicone oil improves the performance. But the further addition of a biocide, particularly the biocides SeaNine 211, Zineb and zinc pyrithione, markedly improves the antifouling performance.

### Example 7

Antifouling coating compositions comprising an alkyl acrylate binder copolymer of MMA/BMA is prepared together with a polyoxyalkylene-modified silicone oil. Further, a sterically hindered amine or a biocide is added. The compositions were subjected to the lab rotor polishing test.

| | Component | | | | | | | | | | | | |
|---|---|---|---|---|---|---|---|---|---|---|---|---|---|
| | properties | | | | | | | | | | | | |
| | (% by weight/ | | | | | | | | | | | | |
| | % volume | Ex 7.1 | | Ex. 7.2 | | Ex 7.3 | | Ex. 7.4 | | Ex. 7.5 | | Ex. 7.6 | |
| Component | solids | % weight | % VS | % weight | % VS | % weight | % VS | % weight | % VS | % weight | % VS | % weight | % VS |
| Rosin | | — | — | — | — | — | — | — | — | — | — | 5.2 | 17.8 |
| Silyl | | — | — | — | — | — | — | — | — | — | — | 21.3 | 36.2 |
| acrylate | | | | | | | | | | | | | |
| binder | | | | | | | | | | | | | |
| Acrylic | MW = | 25.1 | 52.3 | 29.9 | 84.5 | 31.0 | 72 | 28 | 67.4 | 33 | 67.4 | — | — |
| binder | 50-65.000, | | | | | | | | | | | | |
| (MMA/BMA | Tg = | | | | | | | | | | | | |
| copolymer | 60-63° C. | | | | | | | | | | | | |
| plasticizer | | 2.4 | 5.0 | 2.3 | 6.3 | 2.4 | 5.3 | 2.2 | 5 | 2.5 | 5 | — | — |
| Biocide | Copper | — | — | — | — | — | — | — | — | — | — | 3.2 | 6.4 |
| | pyrithione | | | | | | | | | | | | |
| | Cuprous oxide | — | — | — | — | — | — | — | — | — | — | 44.8 | 27.1 |
| | Sea nine 211N | 9.8 | 6 | — | — | — | — | 8.6 | 6 | 10 | 6 | — | — |
| Additives | | 2.7 | 4.1 | 2.8 | 5.5 | 2.6 | 4.3 | 2.4 | 4.0 | 2.8 | 4.0 | 3.1 | 5.6 |
| (thickeners, | | | | | | | | | | | | | |
| wetting agents, | | | | | | | | | | | | | |
| antigelling | | | | | | | | | | | | | |
| agent and | | | | | | | | | | | | | |
| thixotropic | | | | | | | | | | | | | |
| agent) | | | | | | | | | | | | | |
| Sterically | tinuvin123 | 2.1 | 5.0 | — | — | 2 | 5.2 | 1.9 | 5 | 2.2 | 5 | — | — |
| hindered amine | | | | | | | | | | | | | |
| Oil: Polyether- | polyoxy- | 4.4 | 10 | — | — | 4.2 | 10.4 | 3.9 | 10 | 4.5 | 10 | — | — |
| modified | alkylene- | | | | | | | | | | | | |
| dimethylpoly- | modified | | | | | | | | | | | | |
| siloxane | silicone oil | | | | | | | | | | | | |
| | (HLB = 8.6) | | | | | | | | | | | | |
| Pigments | | 5.6 | 2.6 | 4.7 | 3.7 | 5.4 | 2.8 | 5 | 2.6 | 5.8 | 2.6 | 7.9 | 5.9 |
| Fillers | | 16.7 | 15 | — | — | — | — | — | — | | | 0.8 | 1 |
| Solvents | xylene | 28.7 | — | 9.2 | — | 3.5 | — | 45.9 | — | 36.7 | — | 13.7 | — |
| | Butanol | 0.4 | — | 1 | — | 0.4 | — | 0.3 | — | 0.4 | — | — | — |
| | naphta | 2.1 | — | 50.1 | — | 48.5 | — | 1.8 | — | 2.1 | — | — | — |

| | | | | | | | |
|---|---|---|---|---|---|---|---|
| Polishing | 7 months | 0 | 0 | 0 | 0 | 0 | 4.1 |
| (μm/10,000 NM) | | | | | | | |

Table 7 shows that acrylic binders are non-polishing in the lab rotor polishing test compared to a conventional binder system comprising a silyl acrylate and rosin.

### Example 8

Antifouling compositions comprising polyoxyalkylene-modified silicone oils which varies by their HLB-value, are prepared with an acrylic binder (MMA/BMA). The compositions were subjected to an antifouling property test on a raft in Spain for 9 and 13 weeks.

Component

% weight/

| % volume | Component | Ex. 8.1 | | Ex. 8.2 | | Ex. 8.3 | | Ex. 8.4 | | Ex. 8.5 | | Ex. 8.6 | | EX 8.7 | | Ex. 8.8 |
|---|---|---|---|---|---|---|---|---|---|---|---|---|---|---|---|---|
| solids | properties | % wt | % VS | % wt | % VS | % wt | % VS | % wt | % VS | % wt | % VS | % wt | % VS | % wt | % VS | % wt |
| Acrylic | MW = | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| binder | 50-65.000, | | | | | | | | | | | | | | | |
| (MMA/BMA) | Tg = | | | | | | | | | | | | | | | |
| | 60-63° C. | | | | | | | | | | | | | | | |
| Poly- | Silicone | 4.5 | 10 | | | | | | | | | | | | | |
| dimethyl- | Oil | | | | | | | | | | | | | | | |
| poly- | | | | | | | | | | | | | | | | |
| siloxane | | | | | | | | | | | | | | | | |
| Polyether- | HLB:1 | | | 4.4 | 10 | | | | | | | | | | | |
| modified | (X-22-2516) | | | | | | | | | | | | | | | |
| dimethyl- | HLB:4 | | | | | [symbol] | 10 | | | | | | | | | |
| poly- | (KF-6020) | | | | | | | | | | | | | | | |
| siloxane | | | | | | | | | | | | | | | | |
| | HLB:5 | | | | | | | 4.6 | 10 | | | | | | | |
| | (KF-6015) | | | | | | | | | | | | | | | |
| | HLB:10 | | | | | | | | | 4.7 | 10 | | | | | |
| | (KF-353) | | | | | | | | | | | | | | | |
| | HLB:12 | | | | | | | | | | | 4.9 | 10 | | | |
| | (KF-6011) | | | | | | | | | | | | | | | |
| | HLB:14 | | | | | | | | | | | | | [symbol] | 10 | |
| | (KF-643) | | | | | | | | | | | | | | | |
| | HLB: [symbol] | | | | | | | | | | | | | | | 5.0 |
| | (KF-354L) | | | | | | | | | | | | | | | |
| | HLB: [symbol] | | | | | | | | | | | | | | | |
| | HLB: [symbol] | | | | | | | | | | | | | | | |
| | HLB:4 | | | | | | | | | | | | | | | |
| | (KF-6020) | | | | | | | | | | | | | | | |
| | HLB:12 | | | | | | | | | | | | | | | |
| | (KF-6011) | | | | | | | | | | | | | | | |
| Polyether | | | | | | | | | | | | | | | | |
| glycol | | | | | | | | | | | | | | | | |
| PEG/PPG | | | | | | | | | | | | | | | | |
| Solvent | | [symbol] | | [symbol] | | [symbol] | | [symbol] | | [symbol] | | [symbol] | | [symbol] | | [symbol] |

| | | | | | | | | |
|---|---|---|---|---|---|---|---|---|
| Total | 100 | 100 | 100 | 100 | 100 | 100 | 100 | 100 |
| Performance | Poor | Poor | Fair | Good | Poor | Fair | Fair | Fair |
| on raft in | | | | | | | | |
| Spain after | | | | | | | | |
| 9 weeks | | | | | | | | |
| Performance | Fair | Fair | Good | Good | Poor | Fair | Fair | Fair |
| on raft in | | | | | | | | |
| Spain after | | | | | | | | |
| 13 weeks | | | | | | | | |

| Component | | | | | | | | | | | | | | | | |
|---|---|---|---|---|---|---|---|---|---|---|---|---|---|---|---|---|
| % weight/ | | | | | | | | | | | | | | | | |
| % volume | Component | Ex. 8.8 | Ex. 8.9 | | Ex. 8.10 | | Ex 8.11 | | Ex. 8.12 | | Ex. 8.13 | | Ex. 8.14 | | Ex. 8.15 | |
| solids | properties | % VS | % wt | % VS | % wt | % VS | % wt | % VS | % wt | % VS | % wt | % VS | % wt | % VS | % wt | % VS |
| Acrylic | MW = | [symbol] | [symbol] | [symbol] | [symbol] | [symbol] | [symbol] | [symbol] | [symbol] | [symbol] | [symbol] | [symbol] | [symbol] | [symbol] | [symbol] | 100 |
| binder | 50-65.000, | | | | | | | | | | | | | | | |
| (MMA/BMA | Tg = | | | | | | | | | | | | | | | |
| | 60-63° C. | | | | | | | | | | | | | | | |
| Poly- | Silicone | | | | | | | | | | | | | | | |
| dimethyl- | Oil | | | | | | | | | | | | | | | |
| poly- | | | | | | | | | | | | | | | | |
| siloxane | | | | | | | | | | | | | | | | |
| Polyether- | HLB:1 | | | | | | | | | | | | | | | |
| modified | (X-22-2516) | | | | | | | | | | | | | | | |
| dimethyl- | HLB:4 | | | | | | | | | | | | | | | |
| poly- | (KF-6020) | | | | | | | | | | | | | | | |
| siloxane | | | | | | | | | | | | | | | | |
| | HLB:5 | | | | | | | | | | | | | | | |
| | (KF-6015) | | | | | | | | | | | | | | | |
| | HLB:10 | | | | | | | | | | | | | | | |
| | (KF-353) | | | | | | | | | | | | | | | |
| | HLB:12 | | | | | | | | | | | | | | | |
| | (KF-6011) | | | | | | | | | | | | | | | |
| | HLB:14 | | | | | | | | | | | | | | | |
| | (KF-643) | | | | | | | | | | | | | | | |
| | HLB: [symbol] | 10 | | | | | | | | | | | | | | |
| | (KF-354L) | | | | | | | | | | | | | | | |
| | HLB: [symbol] | | 4.7 | 10 | | | | | | | | | | | | |
| | HLB: [symbol] | | | | 10 | 20 | | | | | | | | | | |
| | HLB:4 | | | | | | 9.8 | 20 | | | | | | | | |
| | (KF-6020) | | | | | | | | | | | | | | | |
| | HLB:12 | | | | | | | | 10.4 | 20 | | | | | | |
| | (KF-6011) | | | | | | | | | | | | | | | |
| Polyether | | | | | | | | | | | 5.0 | 10 | | | | |
| glycol | | | | | | | | | | | | | | | | |
| PEG/PPG | | | | | | | | | | | | | 4.7 | 10 | | |
| Solvent | | | [symbol] | | [symbol] | | [symbol] | | [symbol] | | [symbol] | | [symbol] | | 50.0 | |

| | | | | | | | | |
|---|---|---|---|---|---|---|---|---|
| Total | 100 | 100 | 100 | 100 | 100 | 100 | 100 | 100 |
| Performance | Fair | Good | Good | Good | Fair | Poor | Fair | Poor |
| on raft in | | | | | | | | |
| Spain after | | | | | | | | |
| 9 weeks | | | | | | | | |
| Performance | Fair | Good | Good | Good | Fair | Poor | Fair | Poor |
| on raft in | | | | | | | | |
| Spain after | | | | | | | | |
| 13 weeks | | | | | | | | |

[symbol]

indicates data missing or illegible when filed

Table 8 shows Different antifouling properties depending on the nature of the polydimethylsiloxane (PDMS). The PDMS itself does not perform well (Ex. 8.1), but performance increases when oxyalkylene groups are added to the PDMS. The oxyalkylene groups increases the hydrophilicity, and the performance is controlled by the loading of hydrophilic parts. The best performance is achieved for polyoxyalkylene-modified dimethylpolysiloxanes with an HLB at 4 to 8.6 (Ex. 8.3, 8.4, 8.9-8.11). When the HLB is 1, performance is at the level of the PDMS (Ex. 8.2), and when HLB is 10 and above the performance drops again (Ex. 8.5-8.8 and 8.12). Even when oxyalkylene groups are added alone, no increase in performance is observed (Ex. 8.13 and 8.14).

### Example 9

Antifouling compositions comprising the two commercial polyoxyalkylene-modified silicone oils KF-6020 and BYK-333 in increasing amounts. The compositions are prepared with an acrylic binder (MMA/BMA). The compositions were subjected to an antifouling property test on a raft in Spain for 4 weeks.

Table 9 shows that addition of a polyoxyalkylene-modified dimethylpolysiloxane with an HLB of 4 and 8.6 to a non-polishing acrylate coating composition provides a well performing coat, particularly when the HLB of the polyoxyalkylene-modified dimethylpolysiloxane is in the range of 4-10.

Component

% weight/

| % volume | Component | EX. 9.1 | | Ex. 9.2 | | Ex. 9.3 | | Ex. 9.4 | | Ex. 9.5 | | Ex. 9.6 | | Ex. 9.7 | | Ex. 9.8 |
|---|---|---|---|---|---|---|---|---|---|---|---|---|---|---|---|---|
| solids | properties | % wt | % VS | % wt | % VS | % wt | % VS | % wt | % VS | % wt | % VS | % wt | % VS | % wt | % VS | % wt |
| Acrylic | MW = | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| binder | 50-65.000, | | | | | | | | | | | | | | | |
| (MMA/BMA | Tg = | | | | | | | | | | | | | | | |
| copolymer) | 60-63° C. | | | | | | | | | | | | | | | |
| Polyoxy- | BYK-333 | 0.2 | 0.5 | 0.04 | 2.0 | [symbol] | 4.0 | 2.4 | 5.0 | 4.9 | 10.0 | 10.3 | 20.0 | — | | — |
| alkylene- | KF-6020 | — | | — | | — | | — | | — | | — | | 0.2 | 0.5 | [symbol] |
| modified | (HLB = 4) | | | | | | | | | | | | | | | |
| dimethyt- | Commercial | — | | — | | — | | — | | — | | — | | — | | — |
| poly- | oil with | | | | | | | | | | | | | | | |
| siloxane | HLB = 8.6 | | | | | | | | | | | | | | | |
| Solvent | | [symbol] | | [symbol] | | [symbol] | | [symbol] | | [symbol] | | [symbol] | | [symbol] | | [symbol] |

| | | | | | | | | |
|---|---|---|---|---|---|---|---|---|
| Total | 100 | 100 | 100 | 100 | 100 | 100 | 100 | 100 |
| Performance | Poor | Poor | Poor | Poor | Poor | Poor | Poor | Poor |
| on raft in | | | | | | | | |
| Spain after | | | | | | | | |
| 4 weeks | | | | | | | | |

Component

% weight/

| % volume | Component | Ex. 9.8 | Ex. 9.9 | | Ex. 9.10 | | Ex. 9.11 | | Ex. 9.12 | | Ex. 9.13 | | Ex. 9.14 | | Ex. 9.15 | |
|---|---|---|---|---|---|---|---|---|---|---|---|---|---|---|---|---|
| solids | properties | % VS | % wt | % VS | % wt | % VS | % wt | % VS | % wt | % VS | % wt | % VS | % wt | % VS | % wt | % VS |
| Acrylic | MW = | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| binder | 50-65.000, | | | | | | | | | | | | | | | |
| (MMA/BMA | Tg = | | | | | | | | | | | | | | | |
| copolymer) | 60-63° C. | | | | | | | | | | | | | | | |
| Polyoxy- | BYK-333 | | — | | — | | — | | — | | — | | — | | — | |
| alkylene- | KF-6020 | 2.0 | [symbol] | 4.0 | 2.2 | 5.0 | [symbol] | 10.0 | [symbol] | 20.0 | — | | — | | — | |
| modified | (HLB = 4) | | | | | | | | | | | | | | | |
| dimethyt- | Commercial | | — | | — | | — | | — | | 4.7 | 10.0 | [symbol] | 20.0 | — | |
| poly- | oil with | | | | | | | | | | | | | | | |
| siloxane | HLB = 8.6 | | | | | | | | | | | | | | | |
| Solvent | | | [symbol] | | [symbol] | | [symbol] | | [symbol] | | [symbol] | | [symbol] | | [symbol] | |

| | | | | | | | | |
|---|---|---|---|---|---|---|---|---|
| Total | 100 | 100 | 100 | 100 | 100 | 100 | 100 | 100 |
| Performance | Poor | Fair | Fair | Good | Excellent | Good | Excellent | Poor |
| on raft in | | | | | | | | |
| Spain after | | | | | | | | |
| 4 weeks | | | | | | | | |

[symbol]

indicates data missing or illegible when filed

The following numbered aspects are provided:

Aspect 1. An acrylate coating composition for forming an antifouling coat, said composition comprising
a. a binder comprising a (meth)acrylate polymer, wherein said (meth)acrylate polymer is formed by polymerisation of a monomer mixture comprising an alkyl (meth)acrylate monomer, or mixture of alkyl (meth)acrylate monomers, wherein said alkyl (meth)acrylate monomer, or mixture of alkyl (meth)acrylate monomers are present in said monomer mixture in an amount of at least 90% by weight of said monomer mixture;
b. one or more non-reactive polyoxyalkylene-modified silicone oils; and,
c. optionally, one or more solvents.

Aspect 2. The acrylate coating composition according to aspect 1, comprising said (meth)acrylate polymer in an amount of 40-85% volume solids, preferably 50-70% volume solids.

Aspect 3. The acrylate coating composition according to any one of aspects 1-2, wherein said alkyl (meth)acrylate monomer, or mixture of alkyl (meth)acrylate monomers, are present in said monomer mixture in an amount of at least 95%, such as at least 98% or at least 99% by weight of said monomer mixture; or wherein said monomer mixture consists essentially of an alkyl (meth)acrylate monomer, or mixture of alkyl (meth)acrylate monomers.

Aspect 4. The acrylate coating composition according to any one of aspects 1-3, wherein the alkyl (meth)acrylate monomer(s) in said monomer mixture is/are C₁-C₁₀ alkyl (meth)acrylate monomer(s), preferably C₁-C₄ alkyl (meth)acrylate monomers.

Aspect 5. The acrylate coating composition according to any one of the preceding aspects, wherein the alkyl (meth)acrylate monomer(s) in said monomer mixture are selected from methyl (meth)acrylate, ethyl (meth)acrylate, propyl (meth)acrylate or butyl (meth)acrylate, or mixtures thereof, preferably methyl (meth)acrylate or butyl (meth)acrylate, or a mixture of methyl (meth)acrylate and butyl (meth)acrylate.

Aspect 6. The acrylate coating composition according to any one of the preceding aspects, wherein said (meth)acrylate polymer is a homopolymer of methyl acrylate, a homopolymer of butyl acrylate, or a copolymer of methyl acrylate and butyl acrylate.

Aspect 7. The acrylate coating composition according to any one of the preceding aspects, wherein said binder further comprises (d) a silyl (meth)acrylate polymer in an amount of 0-10%, more preferably 0-5% by dry weight of the binder.

Aspect 8. The acrylate coating composition according to any one of the preceding aspects, wherein said binder further comprises (e) a metal (meth)acrylate polymer in an amount of 0-10%, more preferably 0-5% by dry weight of the binder.

Aspect 9. The acrylate coating composition according to any one of aspects 1-6 which does not comprise any silyl (meth)acrylate polymer (d) and/or metal (meth)acrylate polymer (e).

Aspect 10. The acrylate coating composition according to any one of aspects 1-6, comprising said (meth)acrylate polymer as the only acrylate polymer constituent of said binder.

Aspect 11. The acrylate coating composition according to any one of the preceding aspects, wherein the monomer mixture comprises butyl (meth)acrylate monomer, in an amount of at least 50% by weight, such as at least 70% by weight, of said monomer mixture.

Aspect 12. The acrylate coating composition according to any one of the preceding aspects, wherein the (meth)acrylate polymer has a Tg in the range of 20-65° C., preferably 35-65° C., more preferably 40-65° C., even more preferably 45-60° C., or 60-63° C.

Aspect 13. The acrylate coating composition according to any one of the preceding aspects, wherein the (meth)acrylate polymer has a MW in the range 20 000-300 000 g/mol, such as 30 000-200 000 g/mol, even more preferably 75 000-150 000 g/mol, or 30.000-10.000 g/mol, preferably 50.000-80.000 g/mol.

Aspect 14. The acrylate coating composition according to any one of the preceding aspects, comprising said non-reactive polyoxyalkylene-modified silicone oils in a total amount of 5-30% by volume solids, 5-25% by volume solids, preferably 7.5-25% by volume solids, in particular 7.5-20% by volume solids, or 10-20%, or 10-15 by volume solids, or even more preferably 10-30% by volume solids of the coating composition.

Aspect 15. An acrylate coating composition for forming an antifouling coat, said composition comprising
a. a binder comprising a (meth)acrylate polymer, wherein said (meth)acrylate polymer is formed by polymerisation of a monomer mixture comprising an alkyl (meth)acrylate monomer, or mixture of alkyl (meth)acrylate monomers, wherein said alkyl (meth)acrylate monomer, or mixture of alkyl (meth)acrylate monomers are present in said monomer mixture in an amount of at least 90% by weight of said monomer mixture;
b. one or more non-reactive polyoxyalkylene-modified silicone oils in a total amount of 3-25% by dry weight, preferably 5-25%, more preferably 6.7-25%, in particular 6.7-20%, or even more preferably 6.7-15% by dry weight of the coating composition; and,
c. optionally, one or more solvents.

Aspect 16. The acrylate coating composition according to any one of the preceding aspects, wherein the polyoxyalkylene chains of the polyoxyalkylene-modified silicone oils are selected from poly(ethylene glycol) chains, poly(propylene glycol) chains and poly(ethylene glycol-co-propylene glycol) chains, preferably poly(ethylene glycol) chains.

Aspect 17. The acrylate coating composition according to any one of the preceding aspects, wherein the poly(oxyalkylene) chains are selected from poly(ethylene glycol) chains and poly(ethylene glycol-co-propylene glycol) chains, and wherein the weight ratio between ethylene glycol (PEG) and propylene glycol (PPG) is 90:10 to 30:70, preferably 75:25 to 35:65, more preferably 60:40 to 40:60.

Aspect 18. The acrylate coating composition according to any one of the preceding aspects, wherein the one or more non-reactive polyoxyalkylene-modified silicone oils each have an HLB value in the range of 3-10, in particular 4-9.

Aspect 19. The acrylate coating composition according to any one of the preceding aspects, further comprising one or more biocides.

Aspect 20. The acrylate coating composition according to aspect 19, wherein the one or more biocide is a metal-containing biocide selected from bis(1-hydroxy-2(1H)-pyridine-thionato-O,S)-copper (copper pyrithione); copper acrylate; bis(1-hydroxy-2(1H)-pyridine-thionato-O,S)-zinc (zinc pyrithione); zinc-ethylenebis(dithiocarbamate); copper(I)oxide; cuprous oxide; metallic copper; copper metal alloys; metal salts; and bis(N-cyclohexyl-diazenium dioxy) copper.

Aspect 21. The acrylate coating composition according to aspect 19, wherein the one or more biocide is an organic biocide selected from dichlorooctylisothiazolinone (DCOI), (RS)-4-[1-(2,3-dimethylphenyl)ethyl]-3H-imidazole, or 4-brom-2-(4-chlorphenyl)-5-(trifluormethyl)-1H-pyrrol-3-carbonitril, preferably dichlorooctylisothiazolinone (DCOI).

Aspect 22. The acrylate coating composition according to aspect 21, wherein the one or more organic biocides is/are present in a total amount of 0-15% by volume solids, preferably 5-15% volume solids, even more preferably 5-10% volume solids of the coating composition.

Aspect 23. The acrylate coating composition according to any one of aspects 1-18, comprising one or more biocides in a total amount of less than 0.5%, such as less than 0.1% by dry weight of the coating composition, preferably being substantially free of biocides.

Aspect 24. The acrylate coating composition according to any one of the preceding aspects, further comprising one or more sterically hindered amines.

Aspect 25. The acrylate coating composition according to aspect 24, wherein the one or more sterically hindered amines are present in a total amount of 0.06-11.9% by volume solids, such as 0.1-9.8%, or such as 0.13-8.5%, such as 0.16-6.1%, in particular 0.18-3.7% volume solids of the coating composition.

Aspect 26. The acrylate coating composition according to any one of aspects 24-25, wherein the one or more sterically hindered amines have the general formula I:

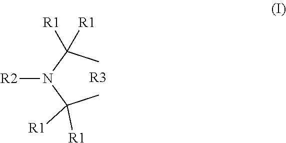

wherein
each R1 is independently linear or branched C₁-C₄ alkyl;
R2 is selected from —H, optionally substituted linear or branched C₁₋₃₀-alkyl, optionally substituted linear or branched C₂₋₃₀-alkenyl, optionally substituted aryl, —OH, optionally substituted linear or branched C₁₋₃₀-alkoxy, optionally substituted linear or branched C₁₋₃₀-alkenyloxy, optionally substituted aryloxy, optionally substituted linear or branched C₁₋₃₀-alkylcarbonyl, optionally substituted C₁₋₃₀-alkenylcarbonyl, and optionally substituted arylcarbonyl;
R3 is an optionally substituted divalent group forming an N-heterocyclic 5-, 6- or 7-membered ring together with the intervening —C(R1)₂—N(R2)-C(R1)₂— group.

Aspect 27. The acrylate coating composition according to any one of aspects 24-26, wherein the one or more sterically hindered amines are 2,2,6,6-tetraalkyl piperidine derivative(s) of general formula II:

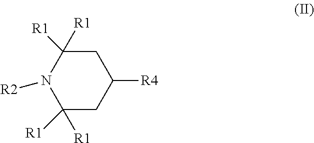

wherein R1 and R2 are defined as for general formula I; and R4 represents hydrogen atom(s) or is one or two substituents selected from C₁₋₃₀-alkyl, C₁₋₃₀-alkenyl, aryl, C₁₋₃₀-alkoxy, C₁₋₃₀-alkenyloxy, aryloxy, C₁₋₃₀-alkylcarbonyl, C₁₋₃₀-alkenylcarbonyl, arylcarbonyl, C₁₋₃₀-alkylcarbonyloxy, C₁₋₃₀-alkenylcarbonyloxy, and arylcarbonyloxy, in particular from C₁₋₈-alkoxy, C₁-s-alkenyloxy, aryloxy, C₁-s-alkylcarbonyloxy, C₁-s-alkenylcarbonyloxy, and arylcarbonyloxy and/or the attachment point(s) for a polymer, wherein two of said substituents for R4 may form a spiro structure; or wherein R4 represents H (where the 4-position of the piperidine is unsubstituted), or one or two substituents selected from C₁₋₃₀-alkyl, C₁₋₃₀-alkenyl, aryl, hydroxy, C₁₋₃₀-alkoxy, C₁₋₃₀-alkenyloxy, aryloxy, C₁₋₃₀-alkylcarbonyl, C₁₋₃₀-alkenylcarbonyl, arylcarbonyl, C₁₋₃₀-alkylcarbonyloxy, C₁₋₃₀-alkenylcarbonyloxy, and arylcarbonyloxy; and wherein the substituent R4 with the before-mentioned meanings may be linked to one or more hindered amine moieties each independently having the General Formula II.

Aspect 28. The acrylate coating composition according to any one of aspects 26-27, wherein R2 is not H and/or R2 is not —OH.

Aspect 29. The acrylate coating composition according to any one of aspects 26-28, wherein the sterically hindered amine(s) are piperidine derivative(s) selected from the following types: N—C₁₋₃₀-alkyl piperidine derivatives, N—C₁₋₃₀-alkenyl piperidine derivatives, N-aryl piperidine derivatives, N—C₁₋₃₀-alkoxy piperidine derivatives, N—C₁₋₃₀-alkenyloxy piperidine derivatives, N-aryloxy piperidine derivatives, N—C₁₋₃₀-alkylcarbonyl piperidine derivatives, N—C₁₋₃₀-alkenylcarbonyl piperidine derivatives, and N-arylcarbonyl piperidine derivatives.

Aspect 30. A non-erodible antifouling coat, said antifouling coat comprising:
a. a binder comprising a (meth)acrylate polymer, as defined in any one of aspects 1-13;
b. one or more non-reactive polyoxyalkylene-modified silicone oils as defined in any one of aspects 14-18,
c. optionally, one or more biocides, as defined in any one of aspects 19-22, and
d. optionally, one or more sterically hindered amines as defined in any one of aspects 24-29.

Aspect 31. The non-erodible antifouling coat according to aspect 30, wherein the polishing is not more than 0.5 μm/10.000 Nautical miles, preferably 0 μm/10.000 Nautical miles, according to the Lab rotor Polishing Rate Test defined herein.

Aspect 32. A substrate, being coated on at least one surface thereof with an antifouling coat according to any one of aspects 30-31.

Aspect 33. A multilayer antifouling coat system, comprising at least two paint coats, at least one of said paint coats being the non-erodible antifouling coat according to any one of aspects 30-31.

Aspect 34. A method for coating a substrate, said method comprising applying the acrylate coating composition as defined in any one of aspects 1-29 to said substrate and allowing the composition to dry.

1. An acrylate coating composition for forming an antifouling coat, said composition comprising
a. a binder comprising a (meth)acrylate polymer, wherein said (meth)acrylate polymer is formed by polymerisation of a monomer mixture comprising an alkyl (meth)acrylate monomer, or mixture of alkyl (meth)acrylate monomers, wherein said alkyl (meth)acrylate monomer, or mixture of alkyl (meth)acrylate monomers are present in said monomer mixture in an amount of at least 90% by weight of said monomer mixture;
b. one or more non-reactive polyoxyalkylene-modified silicone oils in a total amount of 3-25% by dry weight, preferably 5-25%, more preferably 6.7-25%, in particular 6.7-20%, or even more preferably 6.7-15% by dry weight of the coating composition; and,
c. optionally, one or more solvents.

2. The acrylate coating composition according to claim 1, comprising said (meth)acrylate polymer in an amount of 15-75%, preferably 16-60%, even more preferably 18-40%, by dry weight of the coating composition.

3. The acrylate coating composition according to claim 1, wherein said alkyl (meth)acrylate monomer, or mixture of alkyl (meth)acrylate monomers, are present in said monomer mixture in an amount of at least 95%, such as at least 98% or at least 99% by weight of said monomer mixture; or wherein said monomer mixture consists essentially of an alkyl (meth)acrylate monomer, or mixture of alkyl (meth)acrylate monomers.

4. The acrylate coating composition according to claim 1, wherein the alkyl (meth)acrylate monomer(s) in said monomer mixture is/are C₁-C₁₀ alkyl (meth)acrylate monomer(s), preferably C₁-C4 alkyl (meth)acrylate monomers; and preferably wherein the alkyl (meth)acrylate monomer(s) in said monomer mixture are selected from methyl (meth)acrylate, ethyl (meth)acrylate, propyl (meth)acrylate or butyl (meth)acrylate, or mixtures thereof, preferably methyl (meth)acrylate or butyl (meth)acrylate, or a mixture of methyl (meth)acrylate and butyl (meth)acrylate.

5. The acrylate coating composition according to claim 1, wherein said (meth)acrylate polymer is a homopolymer of methyl acrylate, a homopolymer of butyl acrylate, or a copolymer of methyl acrylate and butyl acrylate.

6. The acrylate coating composition according to claim 1 which does not comprise any silyl (meth)acrylate polymer (d) and/or metal (meth)acrylate polymer (e).

7. The acrylate coating composition according to claim 1, comprising said (meth)acrylate polymer as the only acrylate polymer constituent of said binder.

8. The acrylate coating composition according to claim 1, wherein the monomer mixture comprises butyl (meth)acrylate monomer, in an amount of at least 50% by weight, such as at least 70% by weight, of said monomer mixture.

9. The acrylate coating composition according to claim 1, wherein the (meth)acrylate polymer has a Tg in the range of 20-65° C., preferably 35-65° C., more preferably 40-65° C., even more preferably 45-60° C., or 60-63° C.

10. The acrylate coating composition according to claim 1, comprising said non-reactive polyoxyalkylene-modified silicone oils in a total amount of 5-30% by volume solids, preferably 5-25% by volume solids, more preferably 7.5-25% by volume solids, in particular 7.5-20% by volume solids, or 10-20%, or 10-15 by volume solids, even more preferably 10-30% by volume solids of the coating composition.

11. The acrylate coating composition according to claim 1, wherein the polyoxyalkylene chains of the polyoxyalkylene-modified silicone oils are selected from poly(ethylene glycol) chains, poly(propylene glycol) chains and poly(ethylene glycol-co-propylene glycol) chains, preferably poly(ethylene glycol) chains.

12. The acrylate coating composition according to claim 1, wherein the one or more non-reactive polyoxyalkylene-modified silicone oils each have an HLB value in the range of 3-10, in particular 4-9.

13. The acrylate coating composition according to claim 1, further comprising one or more biocides.

14. The acrylate coating composition according to claim 1, comprising one or more biocides in a total amount of less than 0.5%, such as less than 0.1% by dry weight of the coating composition, preferably being substantially free of biocides.

15. The acrylate coating composition according to claim 1, further comprising one or more sterically hindered amines.

16. The acrylate coating composition according to claim 15, comprising said sterically hindered amines in a total amount of 0.05-10%, such as 0.08-8%, or such as 0.1-7%, such as 0.12-5%, in particular 0.15-3%, by dry weight of said coating composition.

17. A non-erodible antifouling coat, said antifouling coat comprising:
a. a binder comprising a (meth)acrylate polymer, wherein said (meth)acrylate polymer is formed by polymerisation of a monomer mixture comprising an alkyl (meth)acrylate monomer, or mixture of alkyl (meth)acrylate monomers, wherein said alkyl (meth)acrylate monomer, or mixture of alkyl(meth)acrylate monomers are present in said monomer mixture in an amount of at least 90% by weight of said monomer mixture;
b. one or more non-reactive polyoxyalkylene-modified silicone oils,
c. optionally, one or more biocides, and
d. optionally, one or more sterically hindered amines.

18. The non-erodible antifouling coat according to claim 16, wherein the polishing is not more than 0.5 μm/10.000 Nautical miles, preferably 0 μm/10.000 Nautical miles, according to the Lab rotor Polishing Rate Test defined herein.

19. A substrate, being coated on at least one surface thereof with an antifouling coat according to claim 17.

20. A multilayer antifouling coat system, comprising at least two paint coats, at least one of said paint coats being the non-erodible antifouling coat according to claim 17.

21. A method for coating a substrate, said method comprising applying the acrylate coating composition as defined in claim 1 to said substrate and allowing the composition to dry.
